(19) United States
(12) Patent Application Publication
(10) Pub. No.: US 2015/0269689 A1
(43) Pub. Date: Sep. 24, 2015

(54) Interactive Real Property Presentation System

(71) Applicants: Steve Ferguson, Georgetown, TX (US); Stuart Sutton, Georgetown, TX (US)

(72) Inventors: Steve Ferguson, Georgetown, TX (US); Stuart Sutton, Georgetown, TX (US)

(21) Appl. No.: 14/218,155

(22) Filed: Mar. 18, 2014

(51) Int. Cl. G06Q 50/16

(52) U.S. Cl. CPC G06Q 50/16

(57) ABSTRACT

Certain embodiments are directed to systems and devices for providing an enhanced presentation of a property based on the location of a user or a device on the property.

### BACKGROUND

Most real estate websites have tools that allow potential buyers to access a limited portion of the listing information in the Multiple Listing Service (MLS). Potential buyers may be given information on or view available properties based on location, type of property, property features, and price ranges. However, once a potential buyer has identified a property on the website, the potential buyer must usually contact a listing agent or another agent to view the property.

Furthermore, while the Multiple Listing Service (MLS) provides valuable information, the MLS does not provide the detailed information a seller has to offer or all the information a buyer desires. Thus, there remains a need for additional devices, systems, and/or methods for providing customized information from a seller to a buyer.

### SUMMARY

Certain embodiments are directed to a presentation system for properties. In certain aspects the systems and methods describe allow sellers to provide a customized presentation of their home. In certain aspects this customized presentation can be provided on-demand. The system includes one or more user interface devices (e.g., mobile devices), computers, and/or servers for storing, retrieving, transmitting, and/or receiving information related to one or more properties, which include, but is not limited to homes and commercial real estate.

Certain embodiments are directed to a system for an enhanced presentation of a property comprising a server having a network interface, storage comprising information related to a plurality of properties, a server controller; a communication network; and a local device comprising one or more of a user interface, a global positioning function, a network interface, and a device controller, configured to provide location and/or property specific information to the local device based on the location of the device or the desired property to be viewed.

Other embodiments are directed to a mobile device configured to display customized location specific information based on the location of the device or user input.

Certain embodiments are directed to a server configured to transmit customized location specific information in response to queries from a device present at a particular location.

Other embodiments are directed to a method of marketing a real property comprising recording a seller or seller's agent sentiment and/or commentary regarding a particular location or characteristic of a property and providing the commentary and/or sentiment as requested or coincident with the location of a buyer on or in the property.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method, system, or device of the invention, and vice versa.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The use of the word “a” or “an” when used in conjunction with the term “comprising” in the claims and/or the specification may mean “one,” but it is also consistent with the meaning of “one or more,” “at least one,” and “one or more than one.”

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1. Illustration of one embodiment of a system that can be used in implementation of the described methods.

FIG. 2. Illustration of an overview of the methods for one embodiment of the described methods.

FIG. 3 Illustration of one embodiment of the account management functions.

FIG. 4 Illustration of one embodiment of a navigation input screen.

FIG. 5 Illustration of one embodiment of a primary login screen.

FIG. 6 Illustration of one embodiment of a login input screen.

FIG. 7 Illustration of one embodiment of a password reset screen.

FIG. 8 Illustration of one embodiment of an invalid user screen.

FIG. 9 Illustration of one embodiment of a membership account screen.

FIG. 10 Illustration of one embodiment of a billing information screen.

FIG. 11 Illustration of one embodiment of a user profile edit screen.

FIG. 12 Illustration of one embodiment of a phone number edit screen.

FIG. 13 Illustration of one embodiment of an invoice screen.

FIG. 14 Illustration of one embodiment of a membership cancel screen.

FIG. 15 Illustration of one embodiment of a member main menu screen.

FIG. 16 Illustration of one embodiment of a house code list screen.

FIG. 17 Illustration of one embodiment of a screen that enables a member to add a home to the member's account.

FIG. 18 Illustration of one embodiment of a house code listing.

FIG. 19 Illustration of one embodiment of an account menu screen.

FIG. 20 Illustration of one embodiment of an upgrade account screen.

FIG. 21 Illustration of one embodiment of an upgrade account receipt/status screen.

FIG. 22 Illustration of one embodiment of a verification screen.

FIG. 23 Illustration of one embodiment of an upload screen.

FIG. 24 Illustration of one embodiment of a menu for upload type screen.

FIG. 25 Illustration of one embodiment of a screen that enables the addition of room description.

FIG. 26 Illustration of one embodiment of a screen for naming a new room.

FIG. 27 Illustration of one embodiment of a room description screen.

FIG. 28 Illustration of one embodiment of a screen that enables the addition or revision of a room description.

FIG. 29 Illustration of one embodiment of a screen that enables the addition of a picture.

FIG. 30 Illustration of one embodiment of a screen displaying a picture.

FIG. 31 Illustration of one embodiment of a screen that enables the addition of audio.

FIG. 32 Illustration of one embodiment of a room listing screen.

FIG. 33 Illustration of one embodiment of a screen that enables the ordering of a room list.

FIG. 34. Illustration of one embodiment of a home list screen.

FIG. 35. Illustration of one embodiment of a screen that enables editing of the house code list.

FIG. 36. Illustration of one embodiment of a user interface screen displaying a find menu.

FIG. 37. Illustration of one embodiment of a user interface screen displaying a GPS location search screen.

FIG. 38. Illustration of one embodiment of a user interface screen displaying a unique identifier screen.

FIG. 39. Illustration of one embodiment of a user interface screen displaying a property menu.

FIG. 40. Illustration of one embodiment of a user interface screen displaying a failed search notification screen.

FIG. 41. Illustration of one embodiment of a user interface screen displaying an address search screen.

FIG. 42. Illustration of one embodiment of a user interface screen displaying an address search screen in process of being populated with a search query.

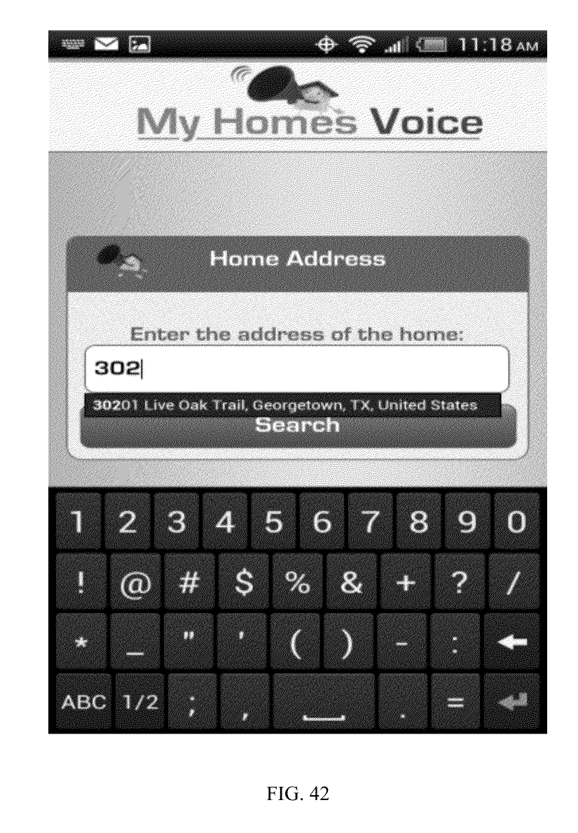

FIG. 43. Illustration of one embodiment of a user interface screen displaying a failed search notification for an address query.

FIG. 44. Illustration of one embodiment of a user interface screen displaying a room list menu that in certain embodiments can be accessed through the property menu.

FIG. 45. Illustration of one embodiment of a user interface screen displaying an email menu.

FIG. 46. Illustration of one embodiment of a user interface screen displaying a call menu.

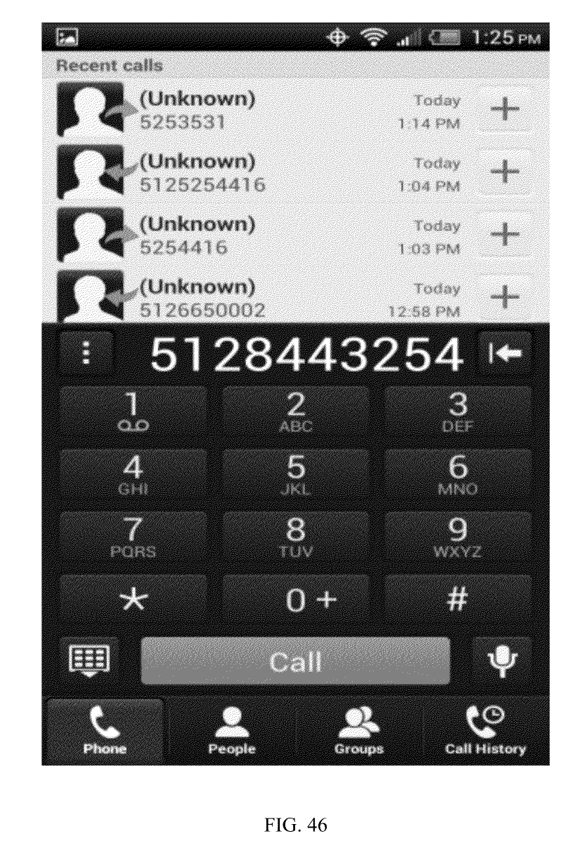

FIG. 47. Illustration of one embodiment of a user interface screen displaying a send menu.

FIG. 48. Illustration of one embodiment of a room description screen.

FIG. 49. Illustration of one embodiment of an audio description screen.

### DESCRIPTION

The following describes systems, devices, and methods that provide a graphic user interface (GUI) to manage communications for a variety of mobile devices, computers, and other electronic devices. The user interface and the underlying software functionality in conjunction with a server manages communications and information related to the marketing and presentation of real property. The system utilizes networked, online, or web-based processing devices, such as servers, as the central processing and database engine for content management and communications. In certain aspects the system is designed to work with any web-accessible or web-accessing device. As a result, the user devices may provide a communications portal to collect information from and present content to the user. The users of the system can be a registered user, which includes a subscriber that has established an account allowing presentation of a property, e.g., a seller, agent (registered seller), or broker; and non-registered users, which includes potential buyers or their agents. In certain aspects the buyer side may also have a second registration or account (registered buyer). In certain aspects defined privileges will be associated with the type of user, e.g., a registered seller will have access and edit privileges to database information, whereas the registered buyer or non-registered user may be denied these privileges.

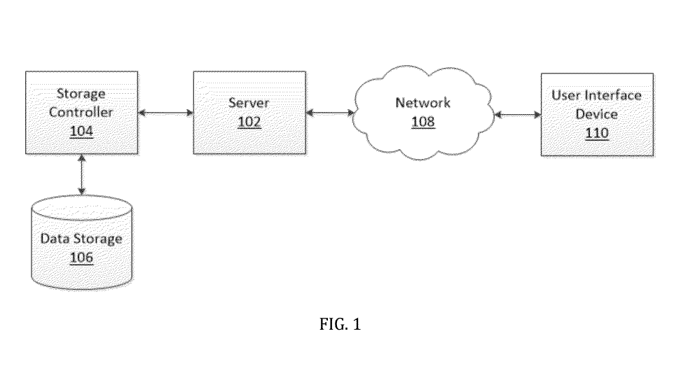

In certain embodiments one or more devices are in communication with one or servers/databases (FIG. 1). A device includes smart phones, tablets, laptop computers, and the like. In certain aspects a user of a device can access instructions for a device (e.g., a device application or app) by downloading the appropriate instructions and/or program from a server or installing an application via the appropriate interface, e.g., via a website. In other embodiments the applications can be web-based applications that can be accessed through a web-interface. In certain aspect a device contains in storage or in a processor an application configured to access, receive, or transmit information to and from a server. Such information can contain location and/or property specific information. Location information is information related to the general location of a target property. In certain aspects property specific information is provided, which is information regarding specific locations on or attributes of the property, such as rooms and the like. In certain aspects the location specific and/or property specific information is stored in a database associated with a server. In certain aspects the property specific information is provided by the seller, which can be a listing agent, the seller, or someone working on behalf of the agent or seller. The property specific information can include information related to attributes of the property that can be seen or those attributes of the property that are unseen (e.g., property history, aspects of construction, construction materials, sentiments from the seller, etc.). The property specific information can be used to emphasize the seller's sentiment and those seen or unseen attributes of the property that are potentially not appreciated by a person touring or viewing the property. In certain aspects the property specific information is provided in a manner that coincides with the location of the buyer in the home or on the property. In certain aspects property specific information is provided by a remote server, e.g., a server not located on the property being viewed.

In certain embodiments the property specific information can be an audio recording or narrated video/presentation. In certain aspects the audio or video recording is played while the device is located in the location associated with a particular recording(s). In certain aspects the presentation is synchronized with the location of the person or device. In a further aspect cues can be provide that are related to a particular location, sub-location, or even a particular viewing direction. Location(s) in or on the property can contain near field communication devices (e.g., radio frequency identifier or Bluetooth transmitter) or visual cues (e.g., quick response codes, bar codes, etc.) that can be detected or read by the device and associated with particular information, description, and/or presentation, including an audio or video presentation. Cues can be associated with a location, sub-location, or even an item in or feature of the location. In other aspects the particular locations and the associated audio and/or video are available on-demand through a GUI.

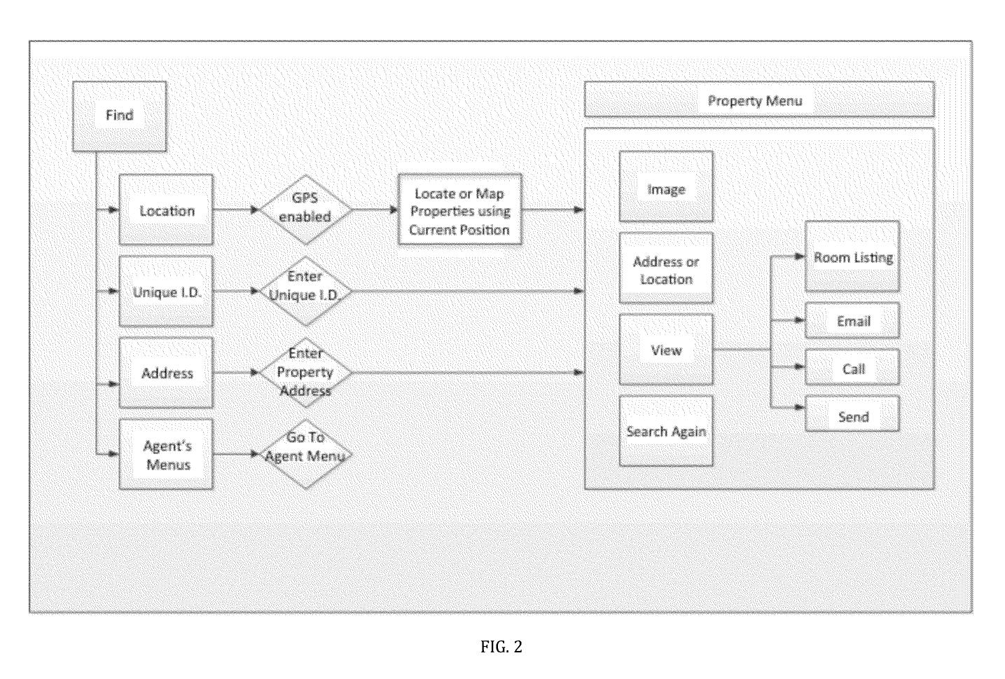

FIG. 2 provides an illustration of one embodiment of a device and its associated functions. In certain aspects the device is an iphone, android, or tablet. In certain embodiments an application can be downloaded to the device via a communication network such as the worldwide web or internet.

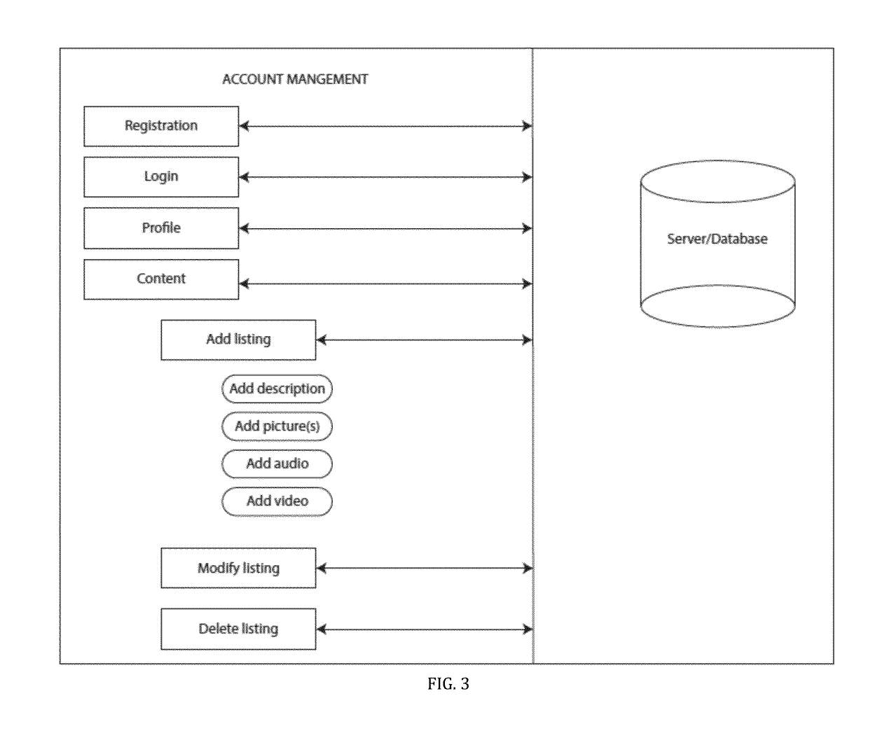

FIG. 3 provides an illustration of one embodiment of the management of information by a registered user and functions associated with a server and its interaction with a device. In certain embodiments information regarding a plurality properties, homes, or commercial real estate is stored by the system and accessible by a server. In certain aspects the server is accessible, at least in part, by an internet interface.

In certain embodiments a registered seller or their agents can provide the property/location information, which is stored and accessed via communication with a server. In certain instances an agent or a broker will purchase or otherwise obtain a subscription to access the system by establishing an account. In this context seller access includes the ability to modify (e.g., revise, add, or delete) data on the server that can be accessed by a third party. Once an account is established the agent or broker will be a registered user or registered seller of the system.

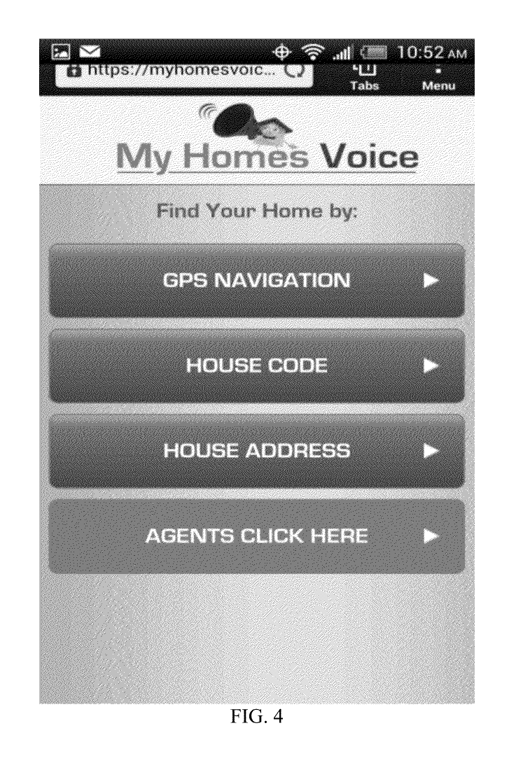

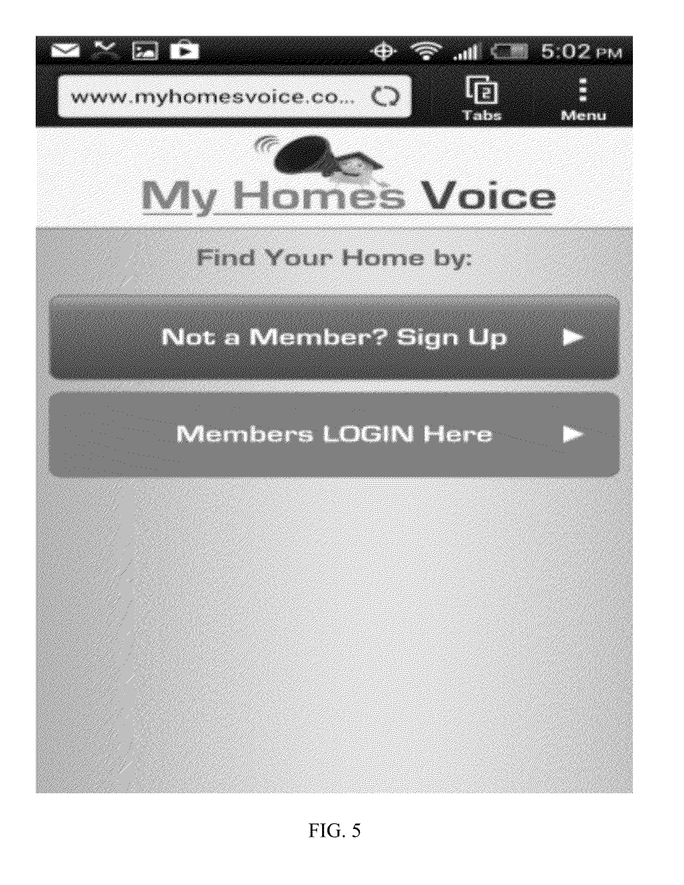

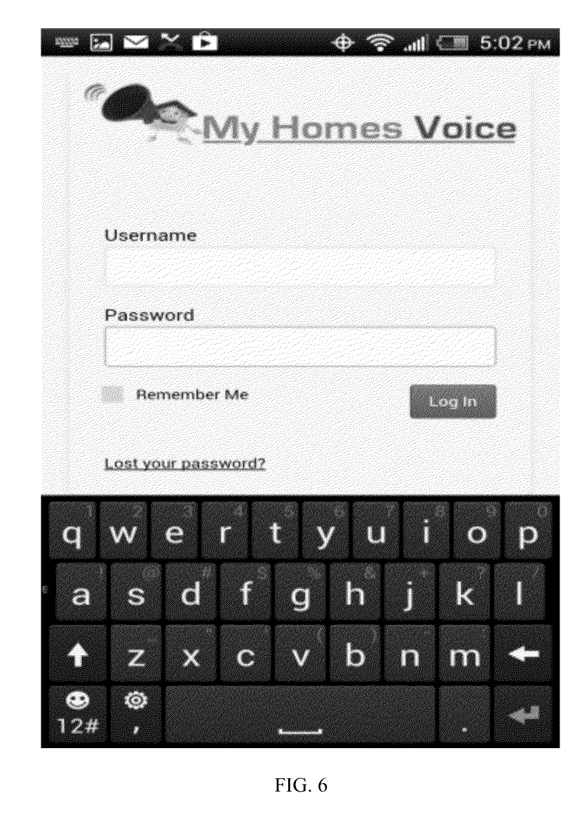

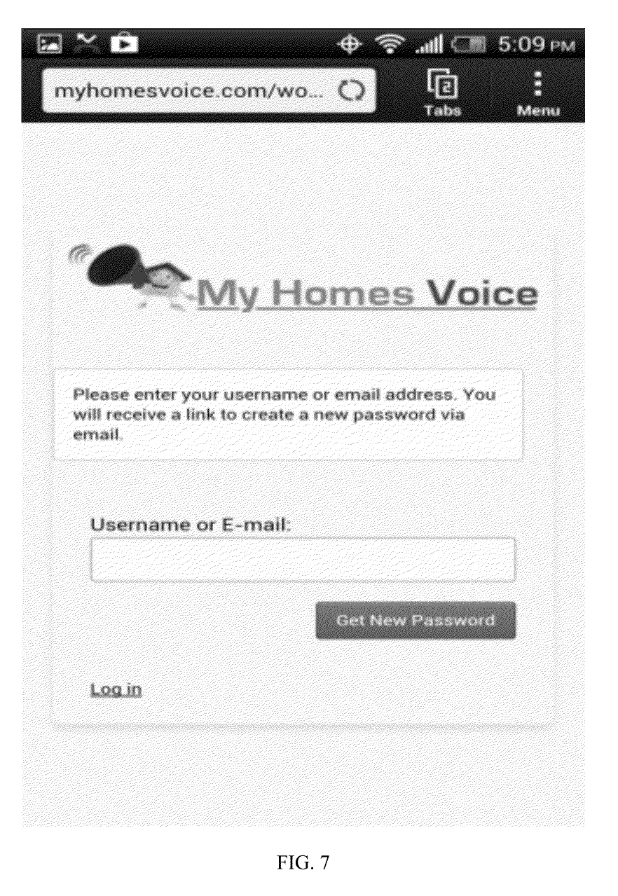

In certain embodiments the device and/or server can provide for Agent and/or seller input. In certain aspects input includes information about the property and/or various locations within a property. A home page menu can include a selection for agents (for an example see FIG. 4). Upon selection of the agent access portion of the GUI an agent's option GUI is displayed. The agent's option GUI can include member login and member registration selections (see FIG. 5 for an example). If an agent is already registered he/she can select member login and proceed by inputting the required information to access the system (for an example see FIGS. 6-8).

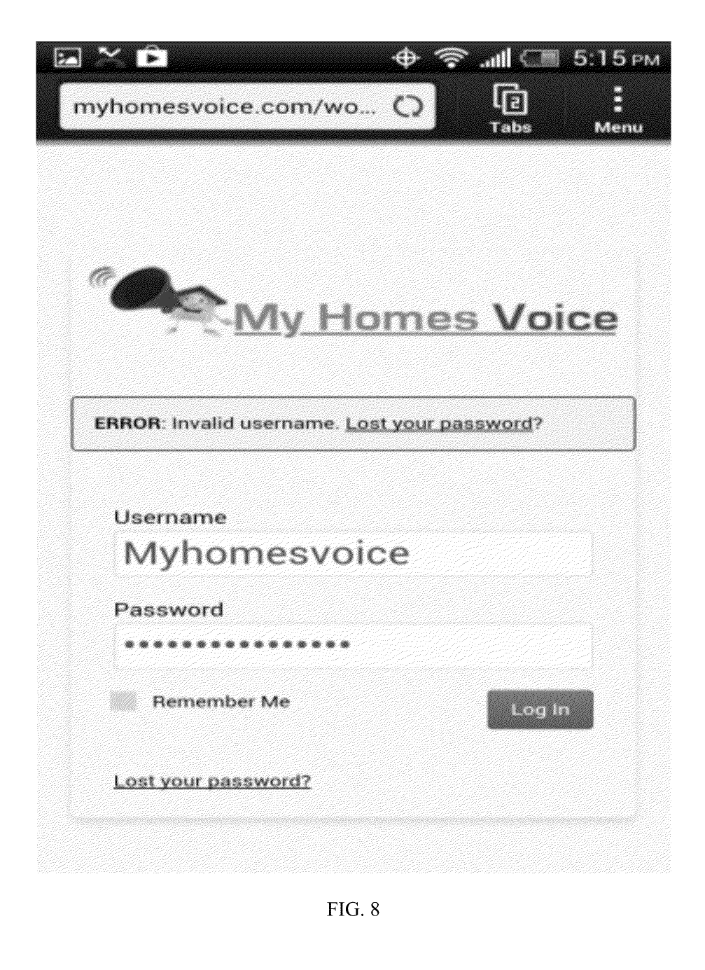

Upon selection of member login the device will display the login screen or GUI that can comprise input fields for the registered agent's login and password, or a lost password selection. If the lost password function is selected a lost password GUI will be displayed (see FIG. 8). The lost password GUI provides selections that will assist the registered agent in identifying the forgotten password or resetting the password. In certain aspects the password will be emailed to registered agent's email address of record. If a registered agent inputs an incorrect username or password the registered agent will be alerted and the device will display a lost your password selection or an input your login credentials again selection. Once the correct login and passwords are submitted the device will display the agent's home page GUI. In certain aspects a non-agent user can access an input system similar to the Agent input but configured for a non-agent user (e.g., a seller). In certain aspects the non-agent user is authorized by the register seller or agent. In other aspects a seller registration system is employed. A registered agent can have a defined level of access associated with the registration, whereas a registered seller can have a distinct and different level of access. In certain aspects the registered seller's access is defined by the registered agent or account holder.

If the agent is not registered he/she can select the registration function and follow the instructions to become a registered agent with the system. In certain aspects the device, when in registration mode, will provide a selection for the registering agent to access general information about the functions of and pricing for accessing the system. In certain aspects the system information describes the operation, benefits, and general description of the system. In a further aspect the registering agent can access video and print media detailing the system, including the benefits and costs associated with the system. The registering agent may select a payment option to complete registration or to select home to return to the home page.

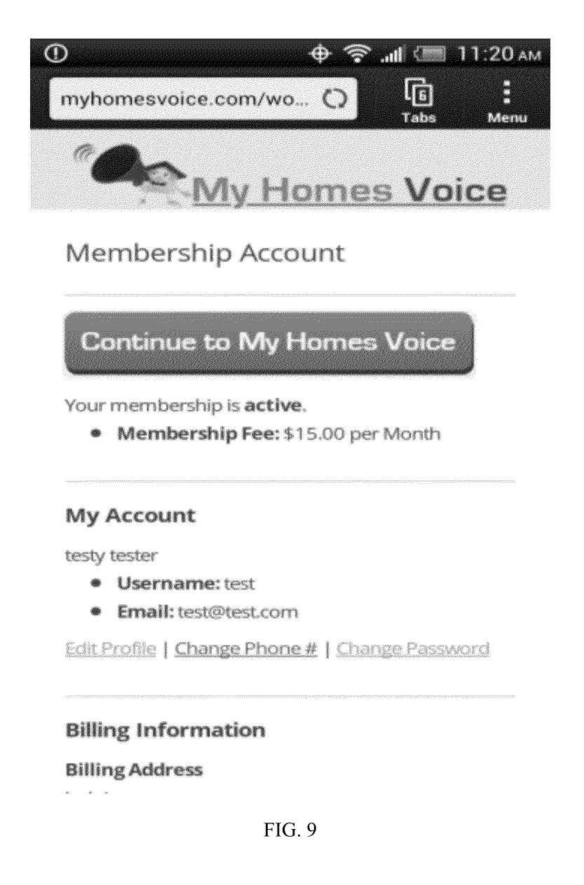

A registered user may be granted at least partial registered user access to information on the server/database, which in this context may allow a registered user to manage information on the system (e.g., revise, add, or delete information). For instance, the server will grant access and will transmit and receive pertinent information in response to an appropriate request received by the server, e.g., a correct login and password. In certain aspects the initial GUI is a membership account portal (see FIG. 9 for an example) and is configured to provide account information and/or a selection to continue to a second main content GUI. In one embodiment the GUI provides an access or request option related to the account information.

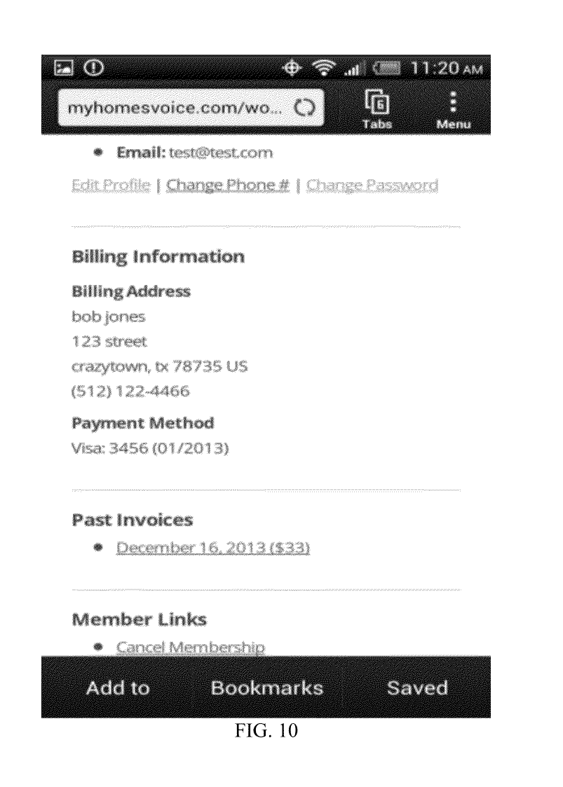

Upon receiving a request for account information access the server will provide for an account summary/subscription management GUI (see FIG. 10 for an example). In certain aspects the server may transmit for display the account status (e.g., whether or not the user's membership is currently active) and/or other information related to the account such as cost of membership, access to account history etc. The cost of membership can be stored or presented in various formats such as annual fee, quarterly fee, or monthly fee for subscription. Other information that can be stored on and provided by the system includes account specific information such as name, email address, etc.

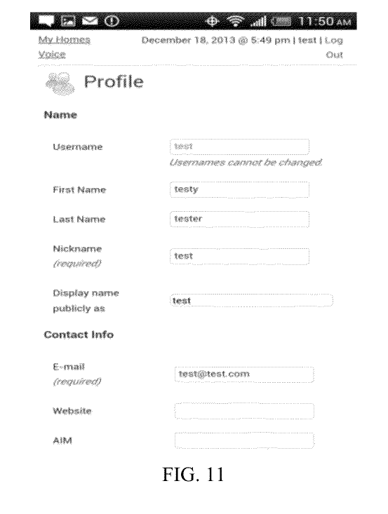

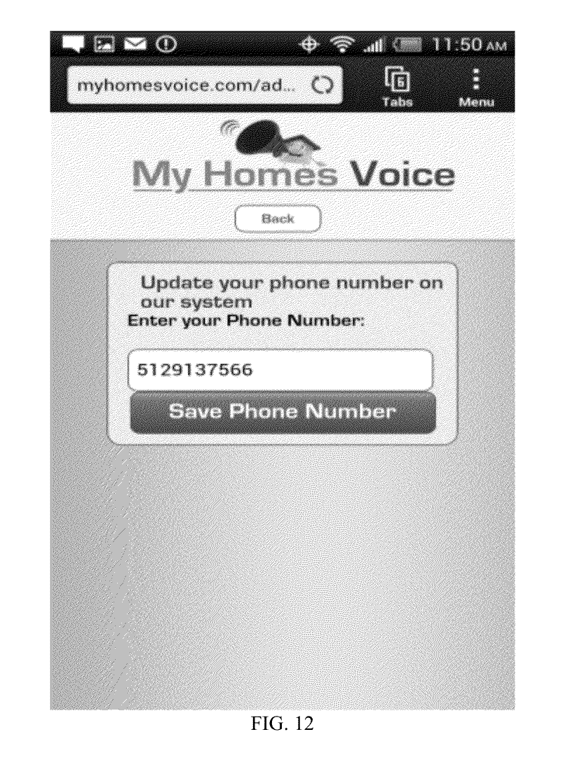

The account summary/subscription management GUI can also provide for display of an option for managing the account profile, such as allowing the user to change their profile, phone number, password, etc. When the server receives a request to change the profile the server will provide for a GUI that allows the user to modify the data associated with account (see for example FIG. 11 and FIG. 12). The server can save any modification and alter the associated information in the database to reflect the changes in the data. For example, if the server receives a request to change the phone number the server can provide for a phone number modification GUI. The server will associate this phone number with a “call agent” option that can be presented when a non-registered user or registered buyer is accessing information.

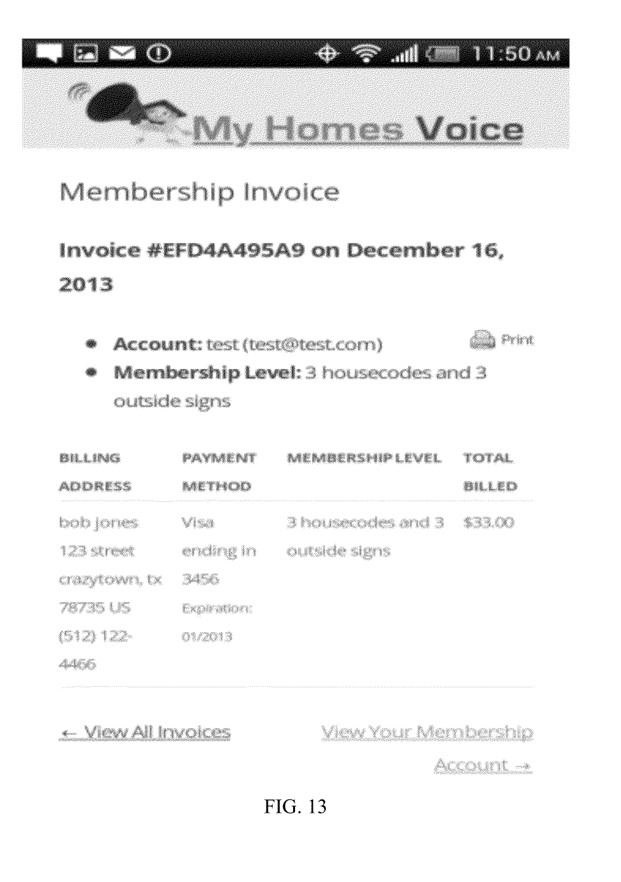

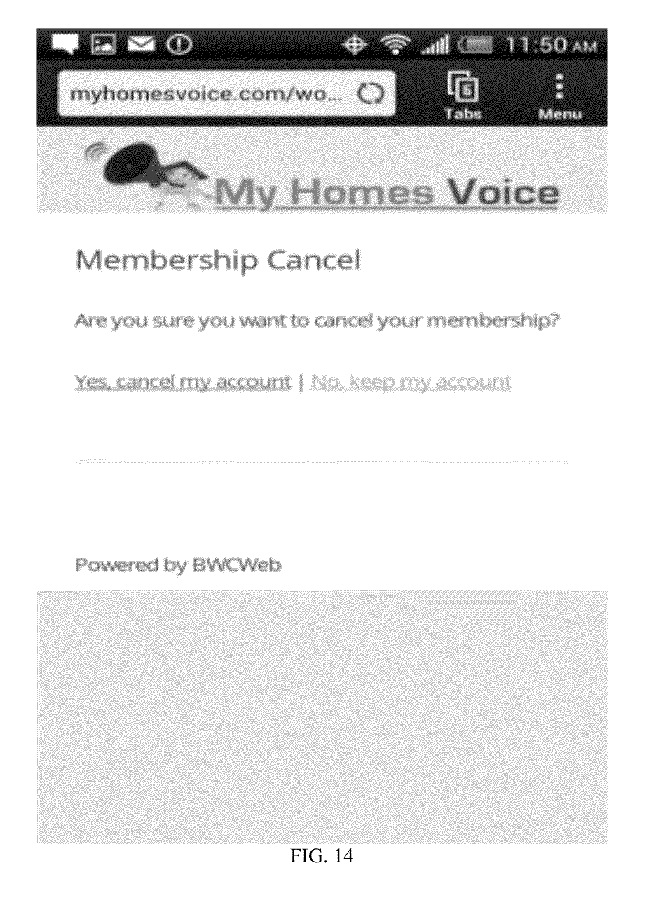

In certain aspects account summary/subscription management GUI displays registered users billing information including full address, phone number, and payment method. The account summary/subscription management GUI can include an access point for past invoices. Activation of the past invoices access point will show, for example, the information related to past, archived, or stored invoices (for example see FIG. 13). The account summary/subscription management GUI can also provide an access point for canceling a membership. An example of a cancel membership GUI is provided in FIG. 14.

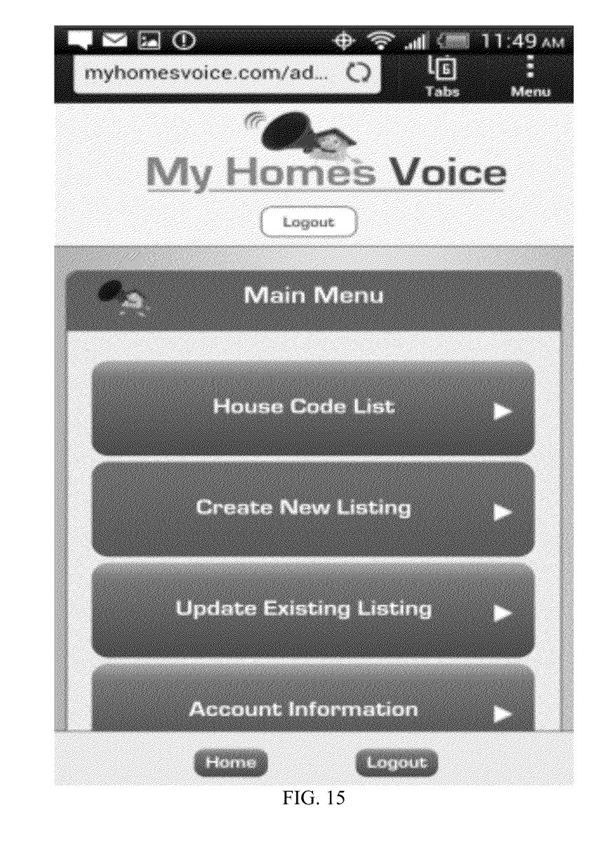

In certain aspects a portal GUI can provide an access point for the seller's agent management GUI (for example see FIG. 15). The seller's agent management GUI can include an option to logout, an option to return to the home portal GUI, or access points for a variety of other functions provided by the system. When the logout access point is activated the server or the device will, after receiving confirmation, logout of the system.

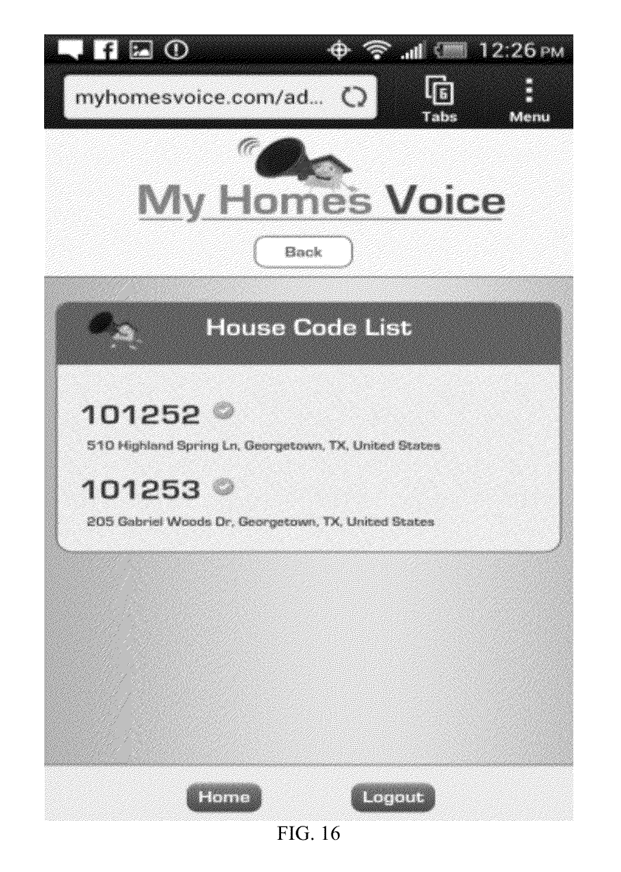

The seller's agent management GUI can present a number of access points to input information related to a new property or home, or delete or modify information related to a home or property already in the system. Access points on the seller's agent management GUI can include (i) accessing a house code listing, (ii) creating a new listing, (iii) modifying an existing listing, and (iv) accessing account information, as well as higher level navigation points such as logout (used to exit the system) and return to home (navigate to the main content GUI) selections (for an example see FIG. 15). A house code list option will direct a user to a selection menu to select a house or property code currently in the system and the addresses of those homes associated with the code (for an example of a house code list GUI, see FIG. 16). In certain aspects the house code GUI will have a “back” selection to return to the seller's agent management GUI.

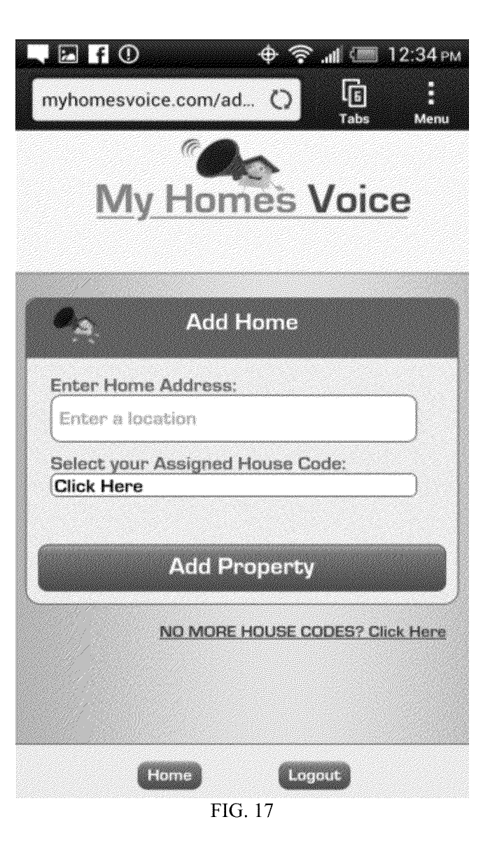

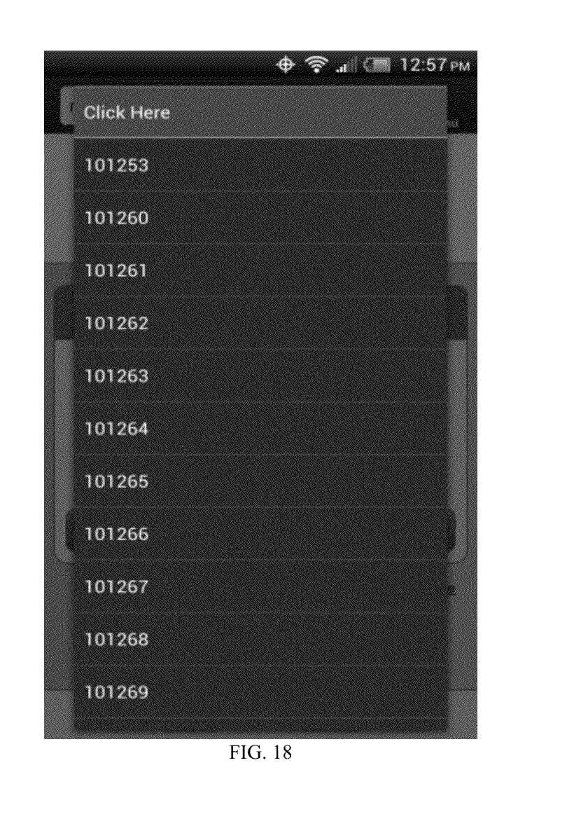

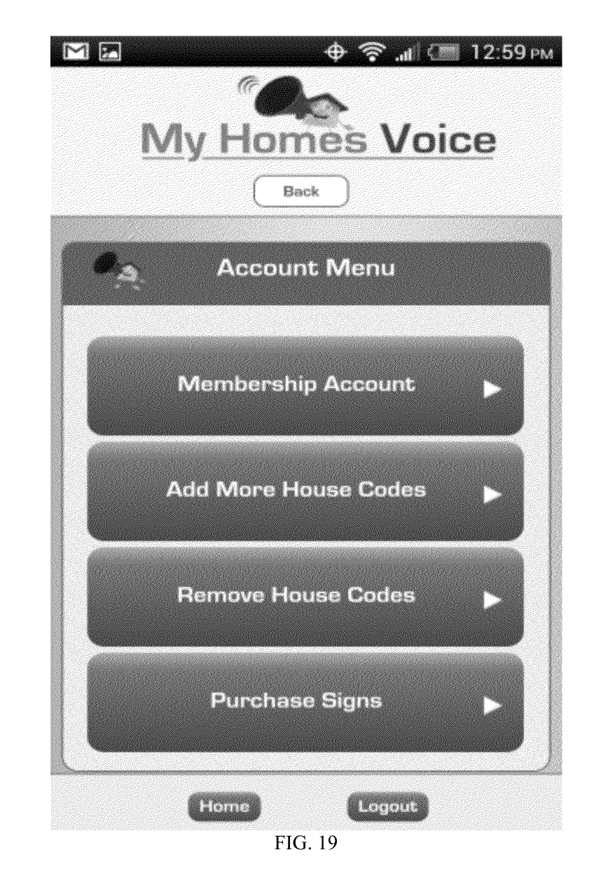

In certain aspects the seller's agent management GUI will include a selection for creating a new listing selection that will initiate a new listing GUI. When selected the registered user will have the ability to add an address and assign a specific code or house code in the system (for an example see FIG. 17). The codes can be generated by the system and purchased individually or in bulk. In certain aspect assigning a specific code will include the automatic listing of the current codes available for use (see FIG. 17 and FIG. 18). If the registered user does not have any current codes available an error notice will be displayed indicating that no codes are available. If no codes are available a selection to navigate to an account menu (for an example see FIG. 19) will be provided for adding and/or purchasing additional codes by selecting add more codes or a similar selection.

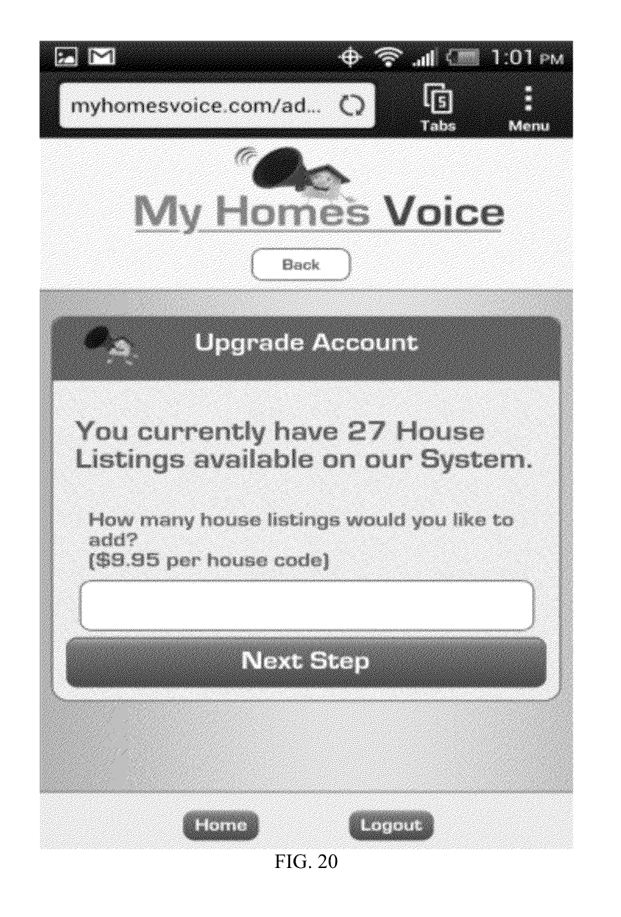

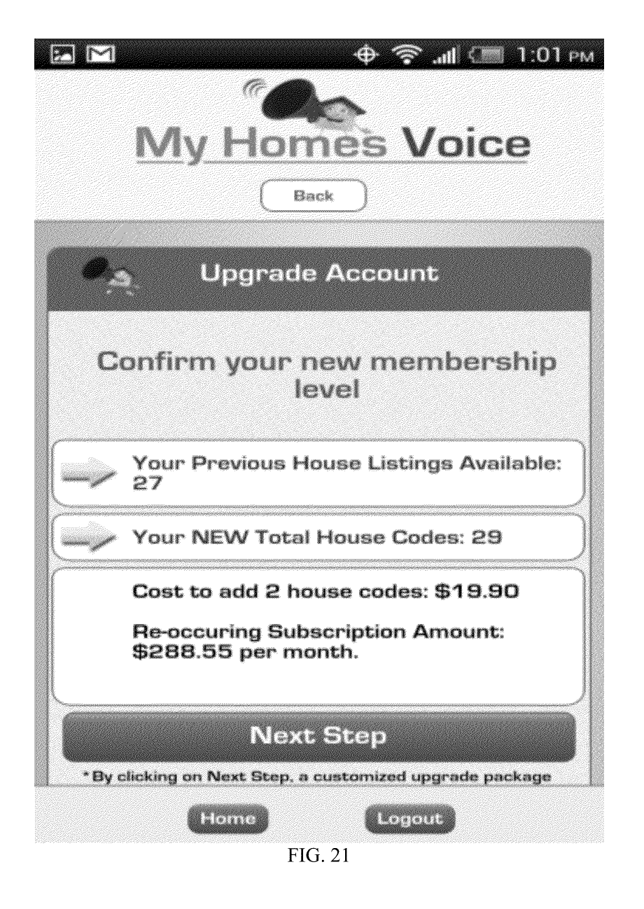

The account menu GUI can include selections to access membership account, add more codes or house codes, remove codes or house codes, purchase accessories (e.g., web advertising, flyers, signs), etc. Once the account menu is displayed a registered user can select how many new codes or house codes to add (see for example FIG. 20). In certain aspects a confirmation can follow the input for the number of new codes or house codes to add showing the new membership totals (for an example see FIG. 21). In certain aspects a payment selection can also be displayed.

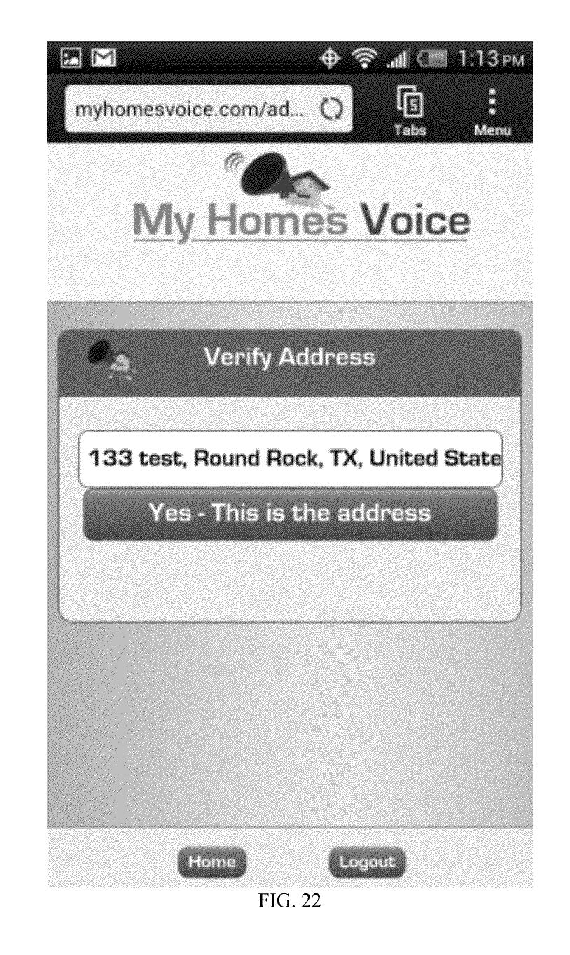

Once a code or house code is selected a new listing can be added to the system. After selecting the option to add a new listing the system will prompt the registered user for an address. Once the registered user provides the address the system will provide an add property selection, which will be followed by a confirmation request (for an example see FIG. 22).

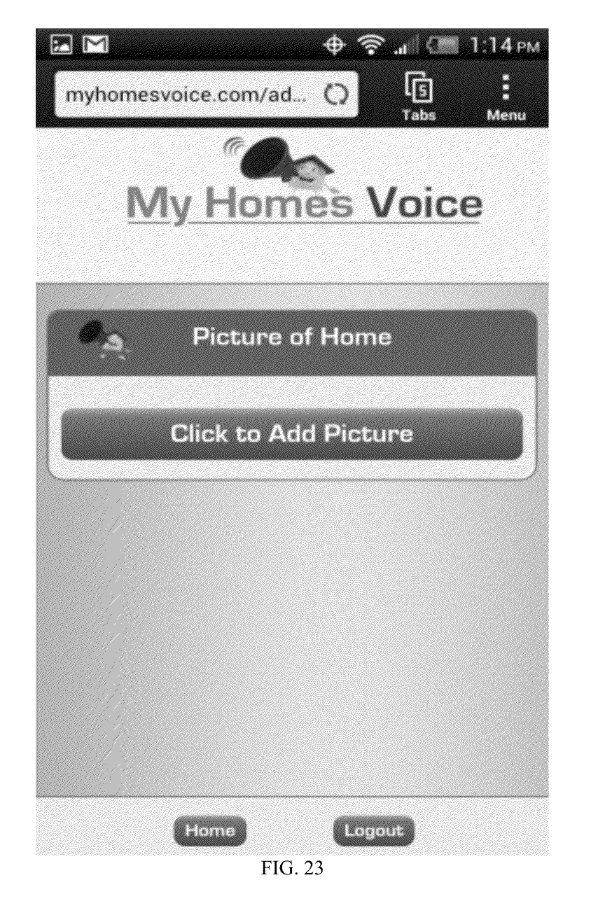

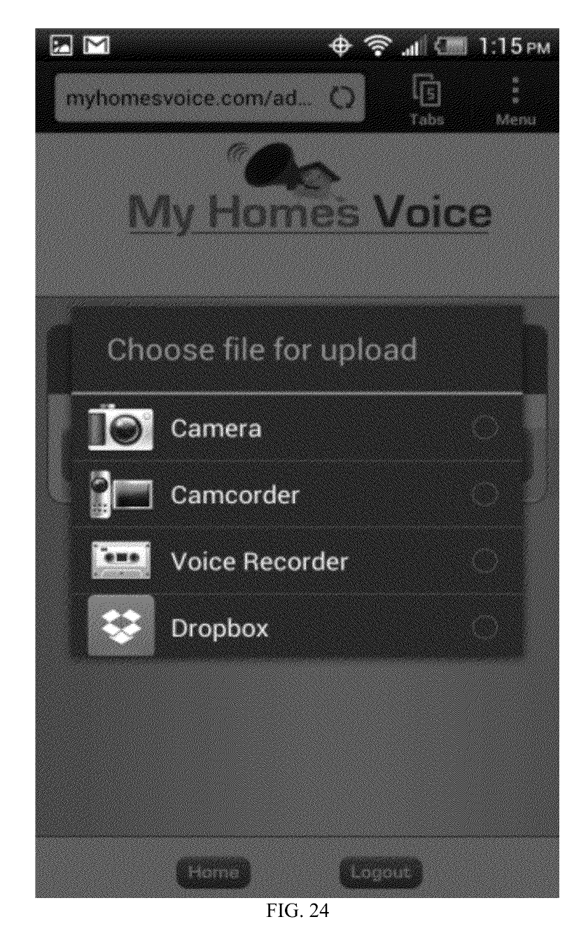

Once a house code or database entry for a property is established the registered agent can add or link property specific information and associate the information with a particular property or listing. An agent, seller, or third party acting on behalf of the seller or agent can be granted access to add information, such as descriptions, picture(s), audio, and/or video to be associated with a property or locations on a property, e.g., room specific information. After confirmation of the listing addition or if accessed through an existing listing the system will prompt the registered user to add information regarding the property or listing, for example the system can prompt the registered user to add a picture(s) (see FIG. 23). The property information can be in a variety of forms, pictures (e.g., JPEG, TIFF, powerpoint, etc.), audio (e.g., WAV, AIFF, MPEG-4, WMA, MP3, etc.), or video (e.g., Quick Time, MPEG, MP4, Flash video, WAV, RM video). After the add picture selector has been activated the system will prompt the registered user for a file for upload (for an example see FIG. 24). In certain aspects the registered user will be given the option of saving the picture or file.

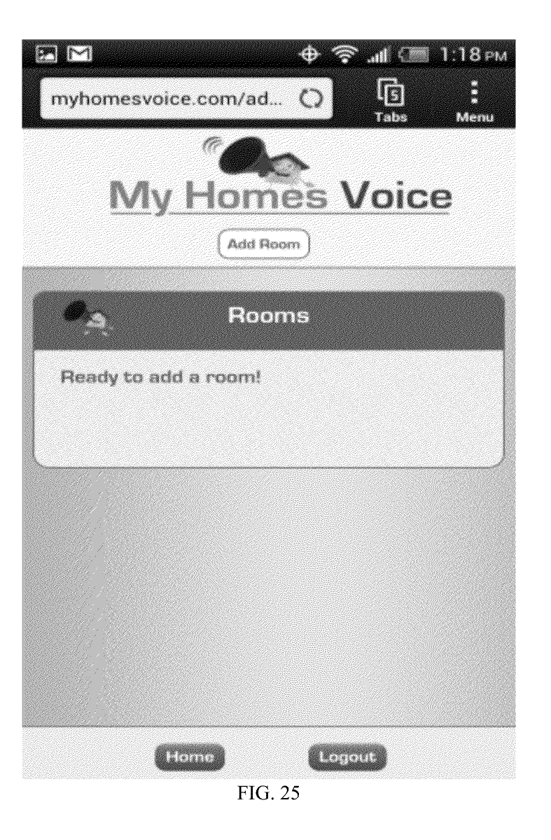

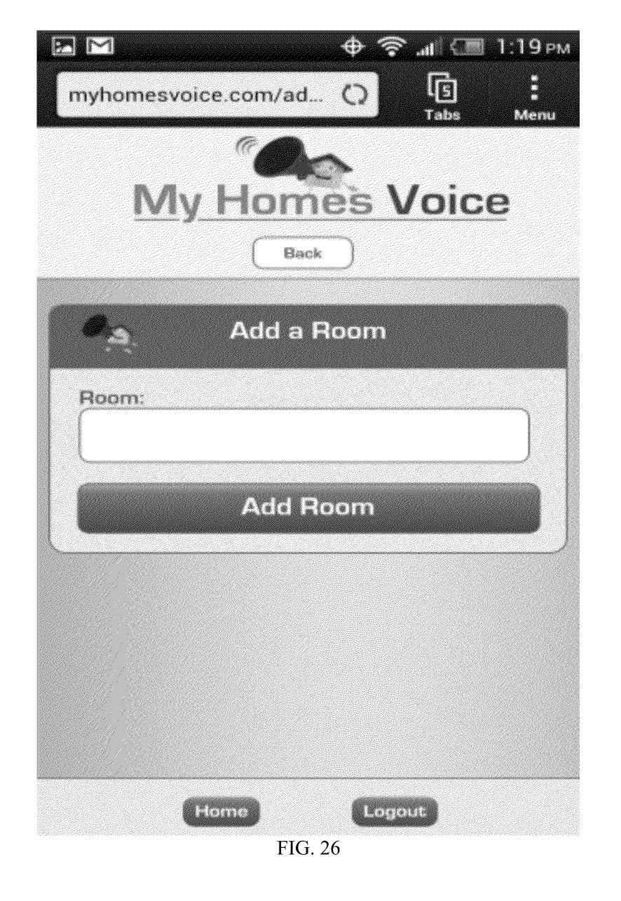

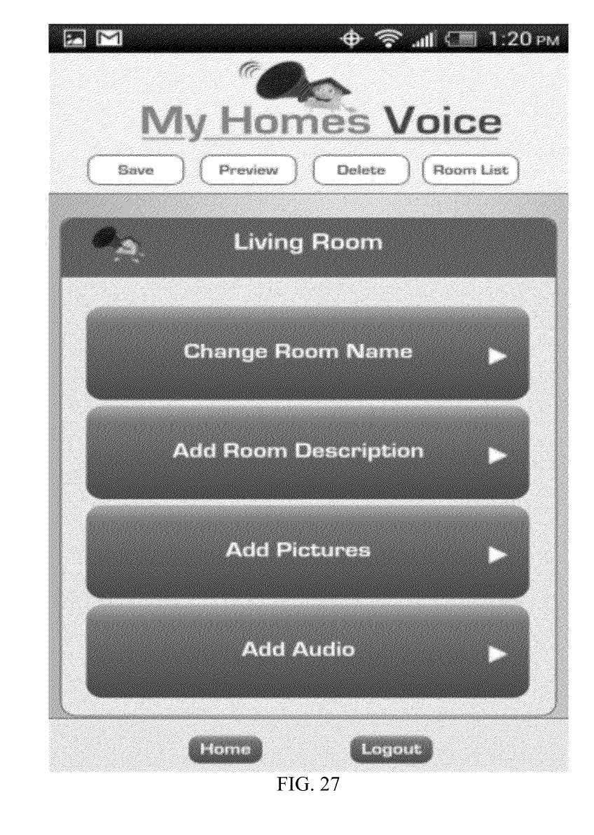

After a code, house code, or listing is created the system will prompt the registered user to add a room/location. An example of a room GUI is provided as FIG. 25. A registered user will be able to select the “add a room” function from the room GUI. Upon selection the registered user will be prompted to name the room being added (for an example see FIG. 26). In certain aspects the name a room field will self-populate the name field with suggestions or provide a dropdown menu of selections that may or may not be accepted by the registered user. Once the room is named a room customization GUI can be displayed (for an example see FIG. 27). In certain aspects the room customization GUI will provide a selection for changing the name, adding a description, adding pictures, adding audio, adding video, etc.

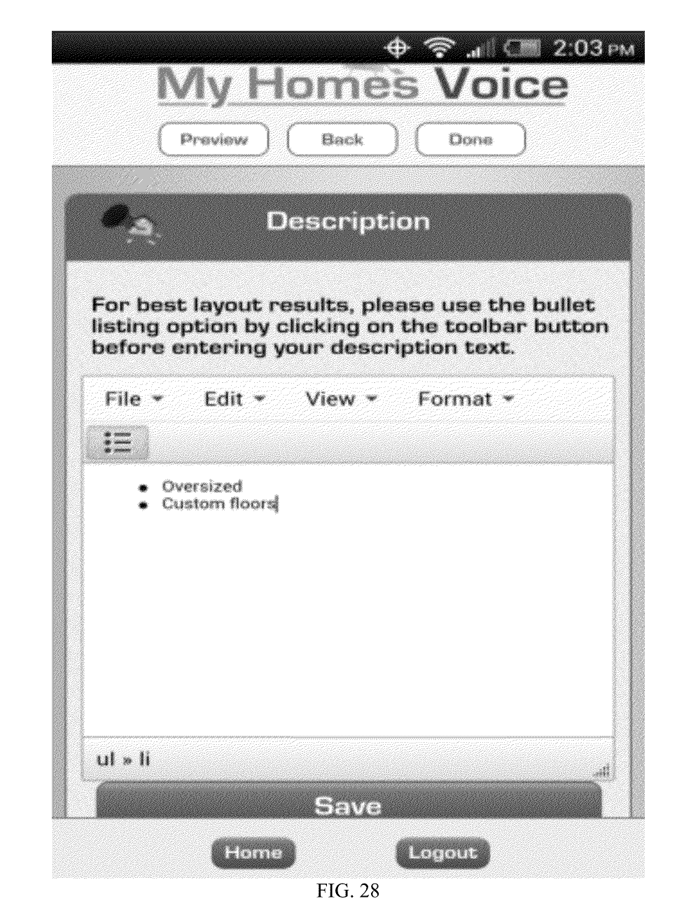

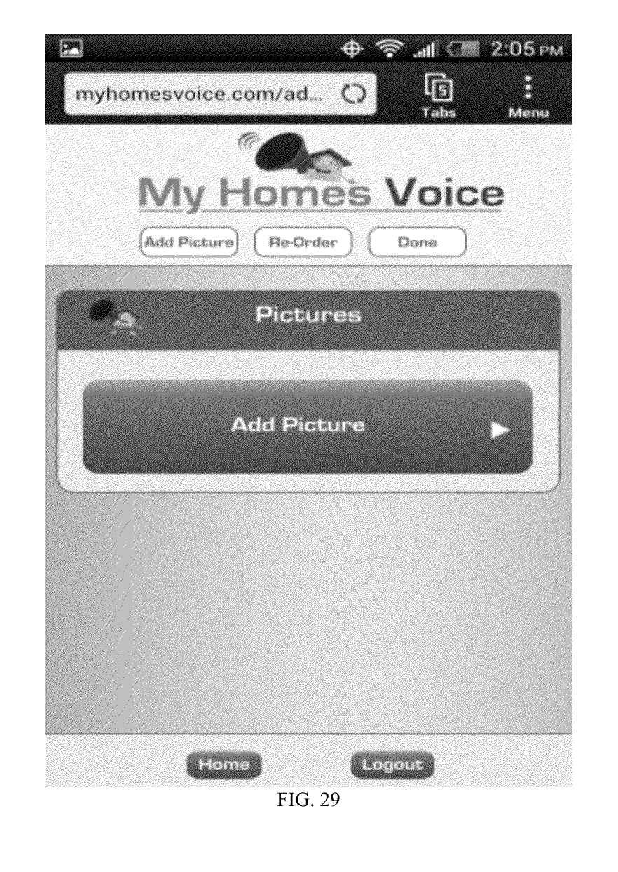

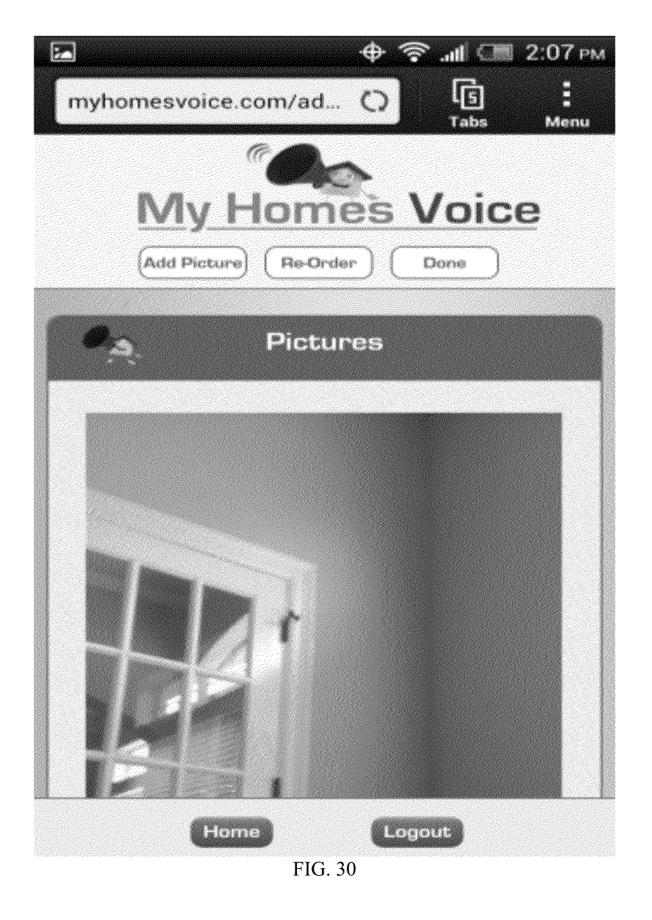

From the room customization menu a registered user can choose to add a description of the room. The description can include commentary from the agent and/or commentary and sentiment from the seller or the seller's family. In certain aspects a room description GUI is used that contains a field for entry of text and a save selection (for an example see FIG. 28). The registered user can add text or other information (e.g., pictures, audio, and/or video as described above) describing the particular room. From the room customization menu a registered user can elect to add information, such as one or more pictures of the room. In certain aspects a picture GUI is displayed to assist in adding a picture (for an example see FIG. 29). The add picture selection can be activated in order to add as many pictures as deemed necessary to showcase the room (for example see FIG. 30). In certain aspects the registered user can choose the program or file type they want to use in order to add the picture. The picture can then be previewed and saved into the system (e.g., transmitted and received by the server/database). If more than one picture is taken or desired then the registered user has the ability to reorder the pictures in whatever order is preferred. The registered user can also associate a picture or file with a particular aspect, e.g., location, sub-location, item, direction, etc. In certain aspects there can be provided a reorder tab, which may include drag/drop functions to place the pictures into the desired order.

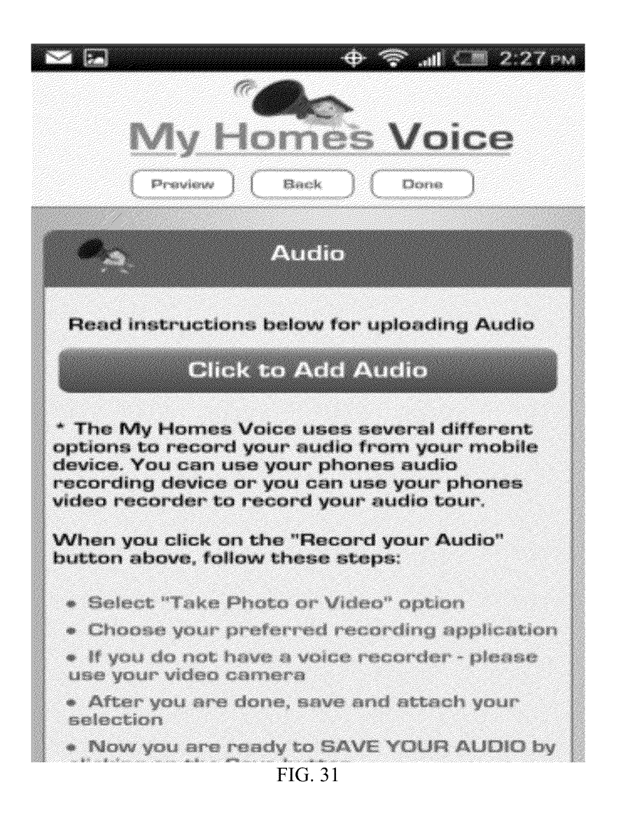

The registered user can use the Add Audio/Video selection from the room menu. A recording (audio or video) for a room can be added (for an example see FIG. 31). The audio/video GUI can provide specific instructions on how to add the audio/video. The audio/video can be pre-recorded and uploaded as a file, or it can be recorded directly to the system. Audio/video can be recorded directly to the system by selecting a record option provided by the audio/video GUI or a prerecorded audio or video can be up loaded. In certain aspects the registered user will be provided with an option to choose the source of an audio/video recording, to record the audio/video, and/or save the audio to the system. These steps would be repeated as many times as necessary to add or edit any number of rooms or entries. Once the room entry is complete it can be previewed by selecting a preview option provided by the GUI. The audio/video can then be transmitted to and received by the server/database for storage.

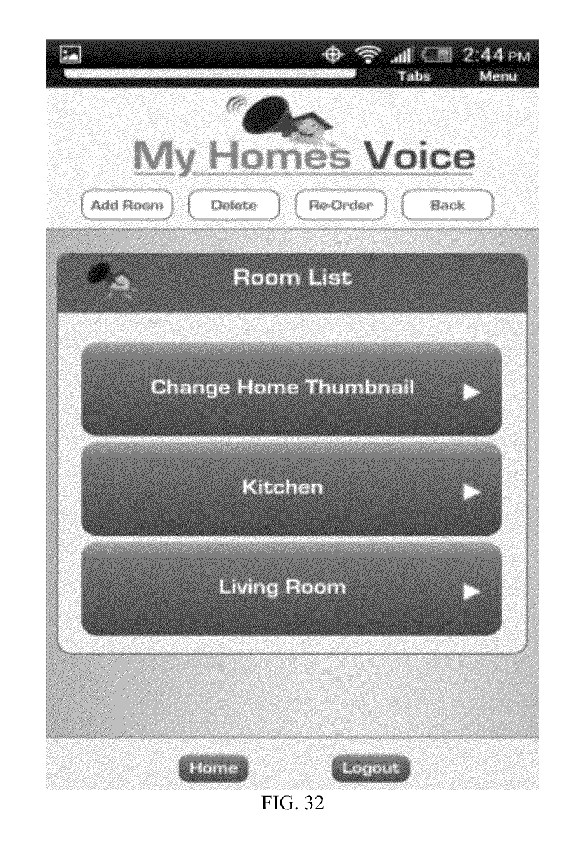

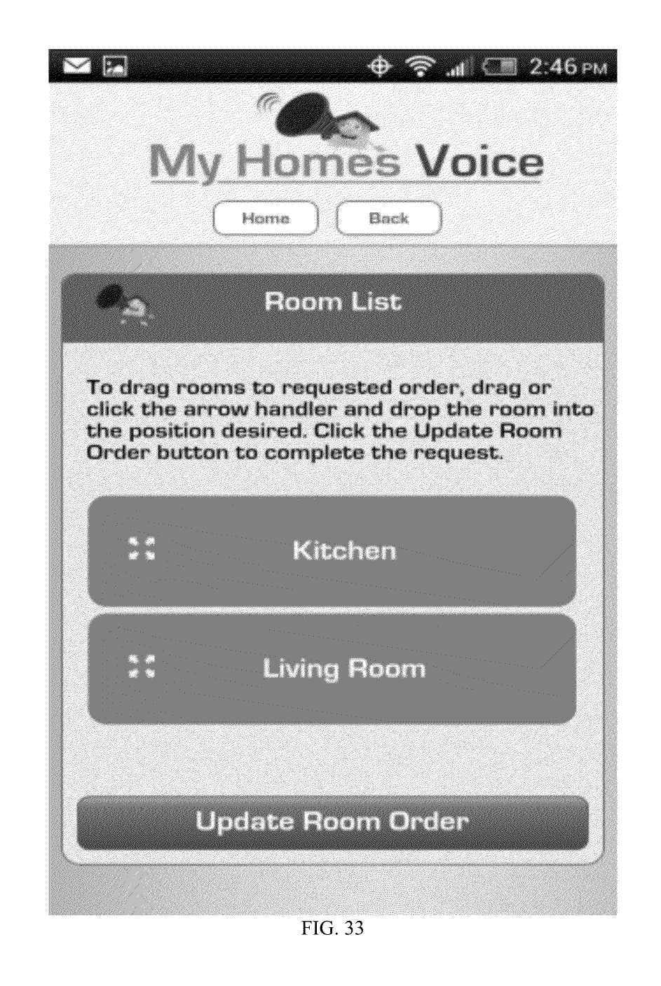

The registered user can view all available rooms or locations associated with a listing by reviewing a room list (for an example see FIG. 32). When the room list is selected it will show the registered user a list rooms or locations for a particular house or property. The room list GUI will provide for a reorder function for the rooms or locations listed. The reorder function can include a drag/drop function (for an example see FIG. 33).

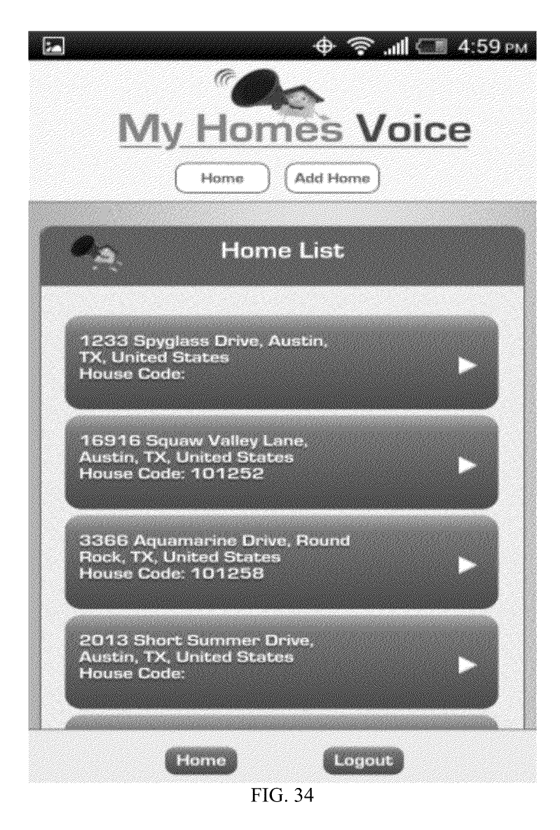

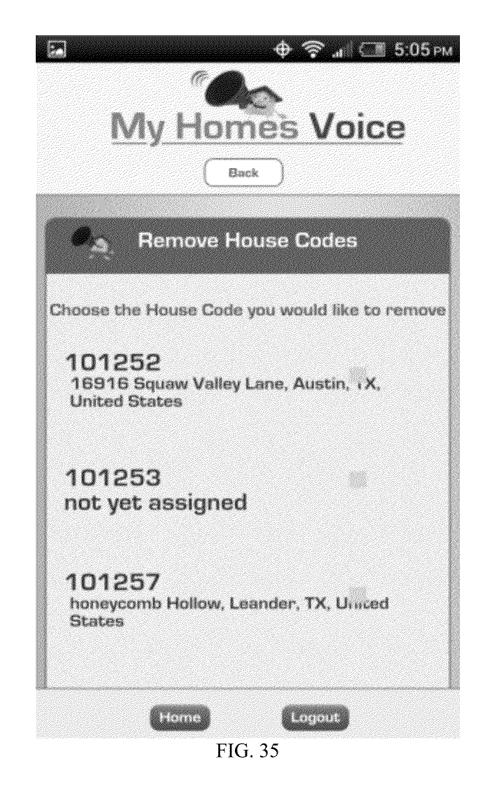

In certain aspects the system will provide for selecting individual listings for review and/modification (for an example see FIG. 34 and FIG. 35).

Accessories can be purchased through the system. For example, a purchase signs selection can be displayed and if selected the system will either route the client directly to a preferred sign company's website so that they can order the signs or the client will be able to order them directly on the system using a catalog/order/checkout interface.

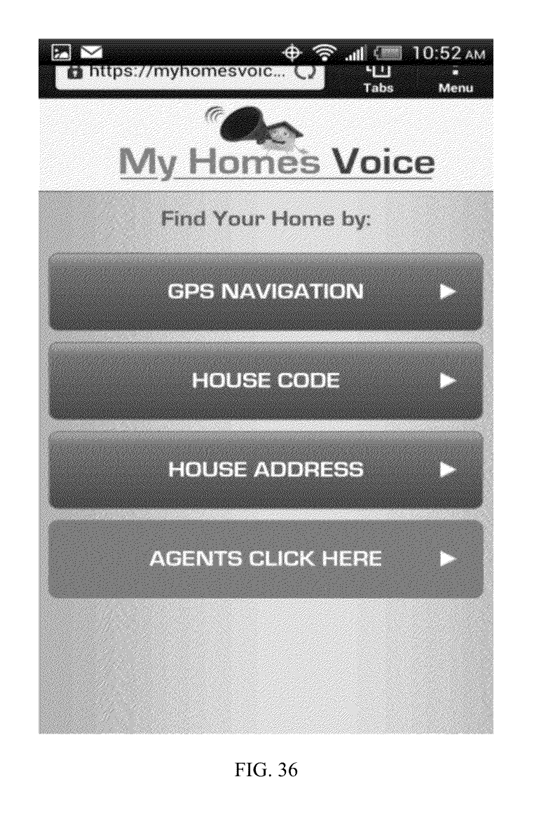

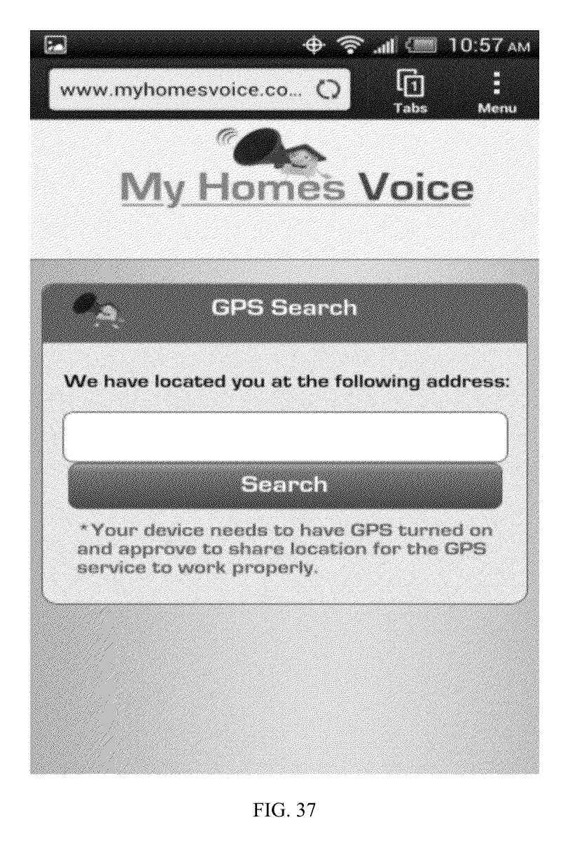

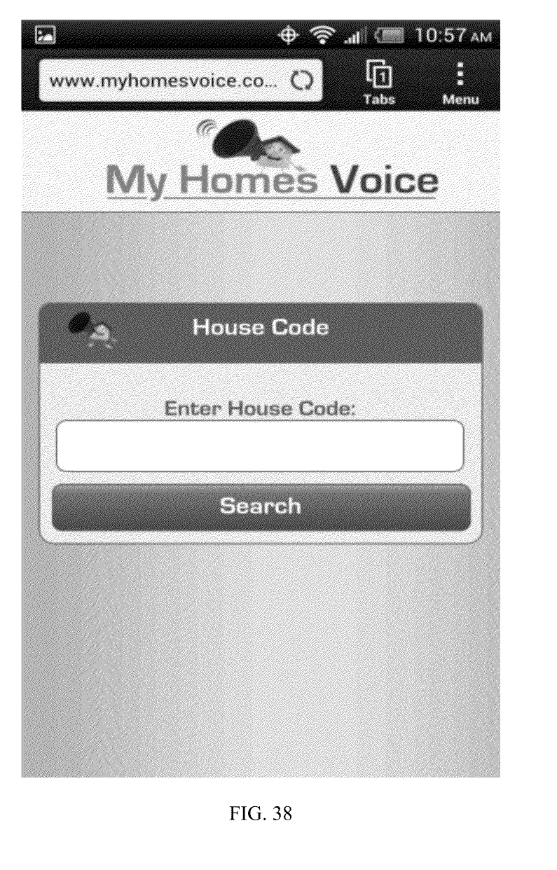

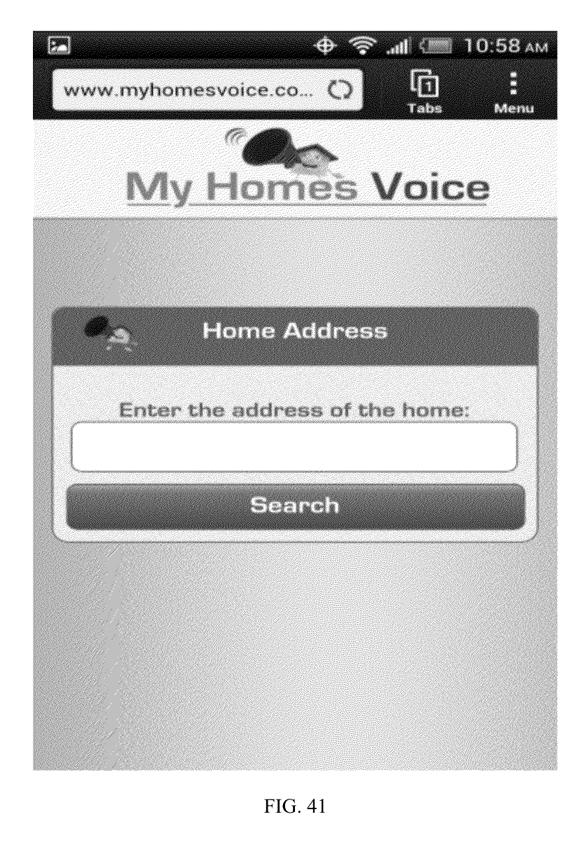

The system/database is populated by a plurality of registered users and can be viewed by a buyer or a registered buyer. In certain embodiments a device can be configured to display search options in a find GUI (see for example FIG. 36). In certain aspects the find GUI is accessed through a home portal. The search options can include, but are not limited to (a) location (e.g., GPS coordinates), (b) unique identifier, or (c) address. The device can be configured to receive user input, auto fill based on user input, or provide input from another device or component of the device. FIG. 37, FIG. 38, and FIG. 41 illustrate an example of a screen enabling a search input by location, unique identifier, and address respectively. In certain aspects the input is an automated input received from another device or component of the device, e.g., GPS coordinates received from a GPS component of the device. In a further aspect the find menus can include a selection for agents or other users. In certain aspects the agent selection is only accessible by an agent registered with the system, as described above.

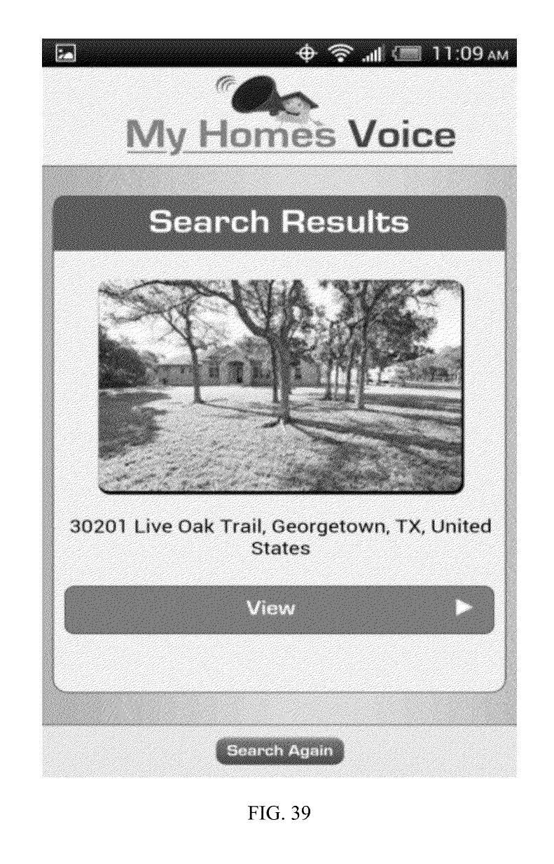

In certain embodiments a device, based on the input received, will access or query a server to send information related to the input, e.g., a location, unique identifier, or property address. In certain embodiments the information accessed or received can populate a property menu, see FIG. 39 for an example of a property menu. In certain aspects a prerecorded message and/or visual presentation (e.g., video, slide show etc.) can be transmitted from the server and received by the device.

In certain aspects, if the GPS feature of the device is activated then a GPS feature will provide the server the location of the user. The server will then provide the appropriate data to the device. In certain aspects the device will display a map with the location of the property or a properties in the vicinity of the location of the user. In certain aspects the server or device can provide information regarding the surrounding area (approximately a ten mile radius from the current location). The information regarding the surrounding area can include information regarding school district, shopping, restaurants, etc.

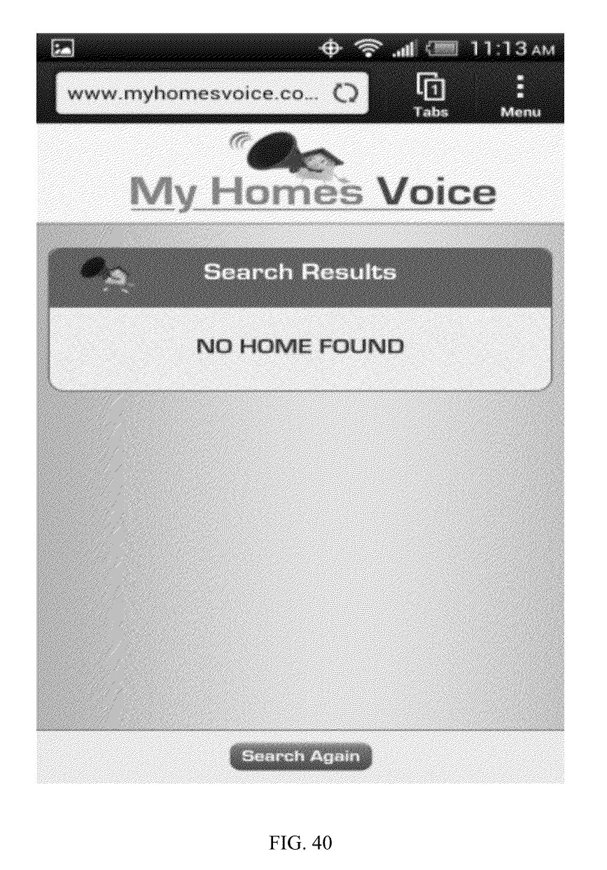

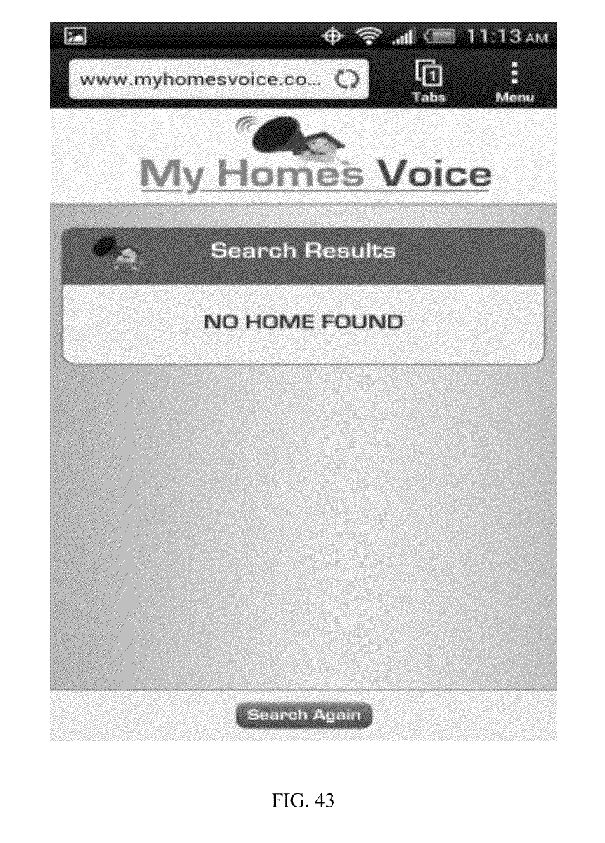

When the user inputs a unique identifier (e.g., a house code) for a property of interest the data associated with that property is retrieved from the server and displayed on the device. In certain aspects a notice will be displayed if the house code is incorrect or if there is no entry available on the server related to the code supplied (e.g., “No house code found” or “Invalid house code”, see FIG. 40 and FIG. 43 for examples). In a further aspect the user can be given the option to input another house code or choose from other locating options, e.g., GPS navigation or home address.

In certain aspects the user may elect to enter an address. When an address is selected the user will be given the option to input the property address. In certain aspects the home address field is a self-populating field. If the address entered does not match a database entry a notification message can be displayed (e.g., “No address matches were found” or “Home address does not exist” or “No matches were found”, see FIG. 40 and FIG. 43 as examples). In the event a matching address is not found the user can be presented an option to re-enter the address or to return to the selection menu.

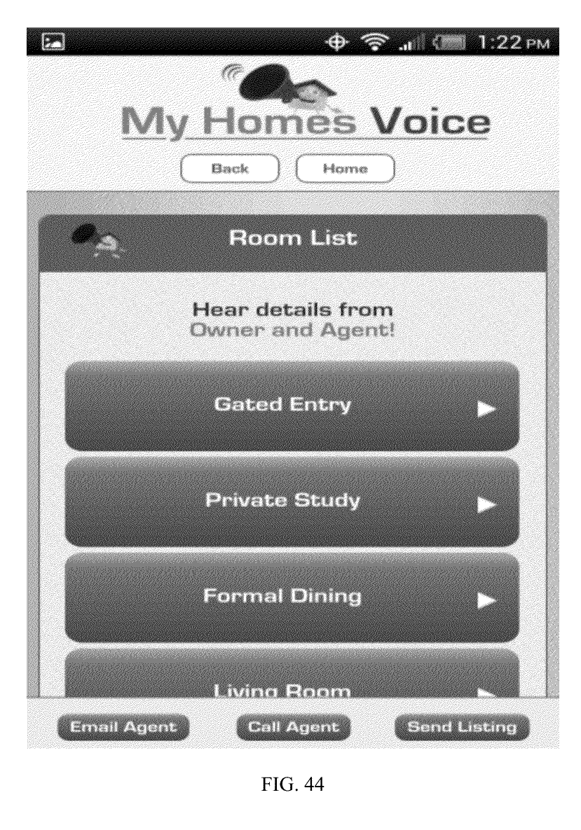

In certain aspects the input is processed and a search results screen is displayed. In certain aspects a picture(s) of the property will be displayed along with the property address (see FIG. 39 for an example). Also displayed in the search results display will be a selection for viewing the selected property and/or a search again selection if the property is not the appropriate property. To view a property the user selects view from the search results display. In response to the view input the device will retrieve the property specific information for display in a view menu. The view menu can provide input for selecting locations on the property, such as living room, garage, bedroom, etc. (see FIG. 44 for an example). In certain aspects the agent and/or seller has provided information related to one or more locations that is associated with appropriate option displayed on the view menu. In certain aspects the locations can be named anything the agent or seller chooses.

In certain aspects a navigation function is activated and the device will be configured to provide property specific information during navigation of the property. The term navigation refers to the physical navigation through a property, e.g., physically walking from room to room in a home. In certain aspects navigation will comprise a GPS guided information queue based on the location of the device on the property, i.e., the device will provide or display information based on the location. The information can comprise one or more recording(s), video(s), pictures, and/or other information as provided by the registered seller, see above. The device can also display a current location on a home diagram and/or a survey. The diagram or survey can be stored on the server and sent to the device when appropriate.

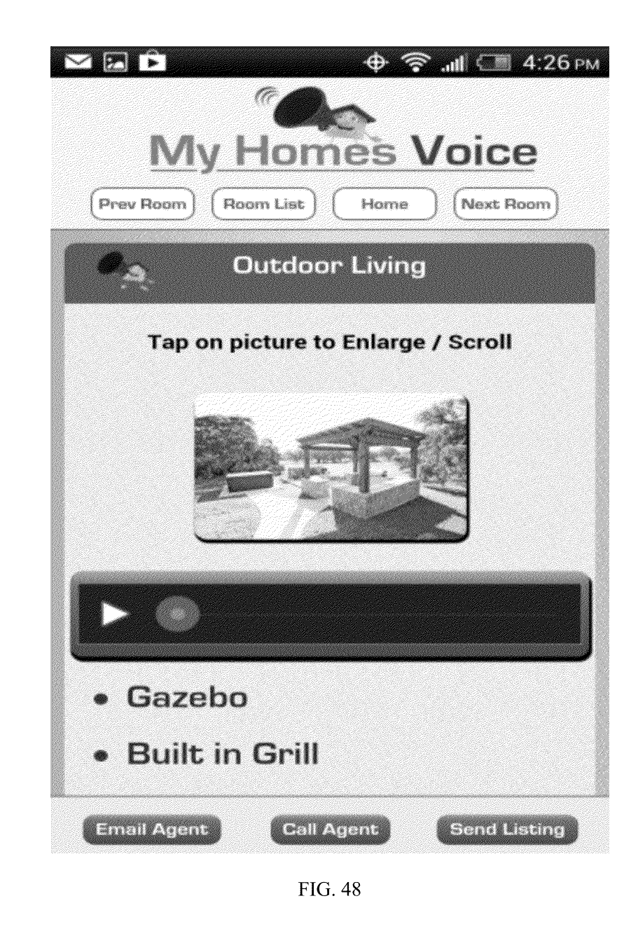

In certain aspects the user can select a location or room, or the device can determine the location of the user. When a location or room is selected the device can display a location/room menu, see FIG. 48, which provides related information and selections to retrieve or request associated information. When the rooms detail GUI is displayed a menu bar can be included in the GUI and may include, but is not limited to a previous room, a room list, home, or a next room selection. Upon selection of a previous room the information related to the previous room viewed on the device will be presented to the user. Upon selection of location/room list the device displays a list of the available locations/rooms available for a property. Upon selection of home the device displays initial navigation menu, which can provide for another search. Upon selection of next location/room the device displays information related to the next location/room in the location/room list. In certain aspects the location/room list is ordered and entered by the agent, the seller, or their behalf. In certain aspects additional menu bars can be included in the display including one having the Email Agent, Call Agent, or Send Listing selections.

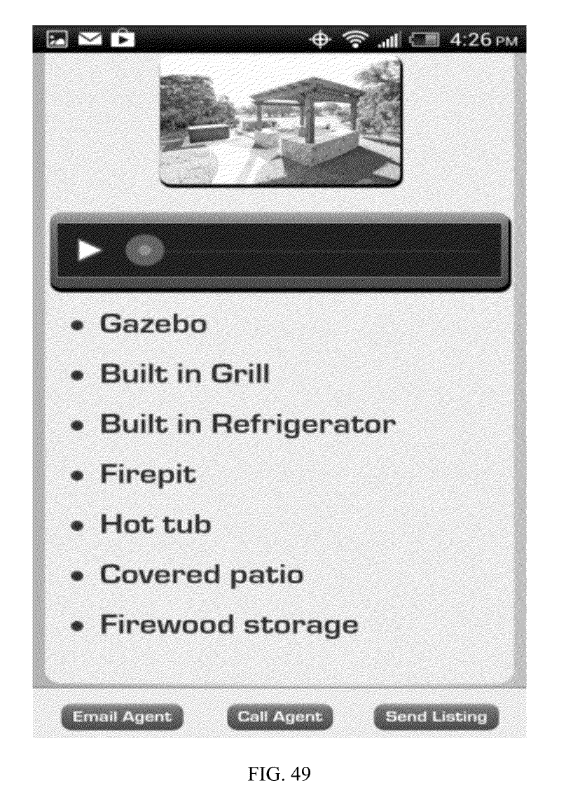

In certain aspects the room detail menu displays an indicator of how many pictures and/or videos are available for the selected room. In certain aspects a picture can be enlarged. If more than one picture is available the device can display additional pictures. In certain aspects a set of thumbnail pictures or videos are provided, each of which can be selected to see the full view. In certain embodiments the device will start a video or slide show of a selected room or provide an option to start a video or slide show when entering a room. In certain aspects a positioning system determines when a room is entered and the device initiates the video or slide show of the room being entered without any instructions from the user. In certain aspects the device can provide a start video or slide show selection. In certain embodiments an audio selection can be displayed associated with a picture on the room screen. The device will play pre-recorded audio associate with the picture or location when audio is selected. In certain aspects the audio is a recording of listing agent, seller, or other person providing information, commentary, or sentiment regarding the selected location/room or the location/room in which the device is located. In certain aspects a display is associated with the audio that provides information synchronized with the audio. In a further aspect the information can be presented in the form bullet points or notes (see FIG. 49 for an example).

The view menu can also include a feedback selection. The feedback selection provides an input/output that allows the seller's agent or the seller to give specific details in regards to the home, answer questions regarding the home, etc. The feedback function can also provide for the buyer and buyer's agent to provide comments, such as whether potential buyers liked the home, notification of a potential offer, recommendations or dislikes of the potential buyers, etc. In certain aspects the feedback can be emailed or otherwise transmitted directly to the listing agent for review or stored on the server with a notification sent to the listing agent that feedback is available.

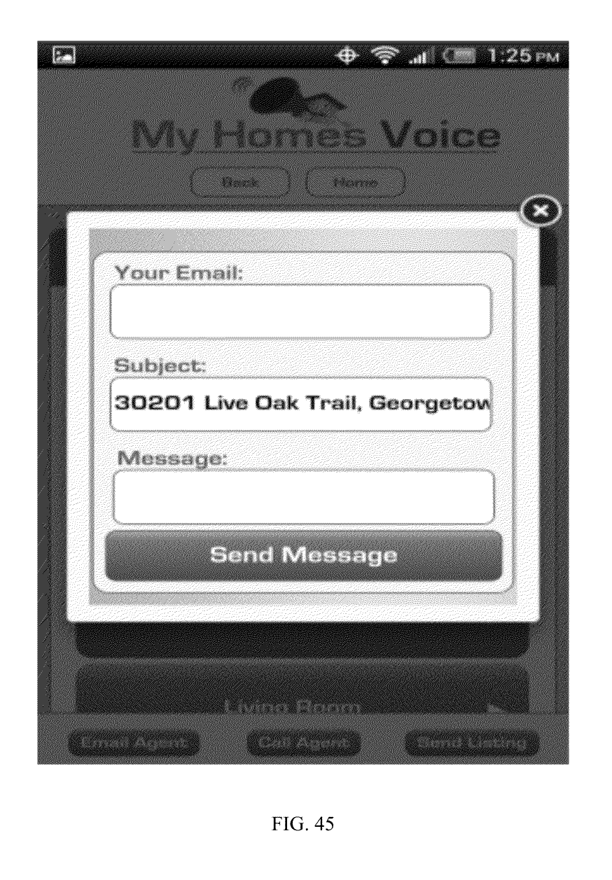

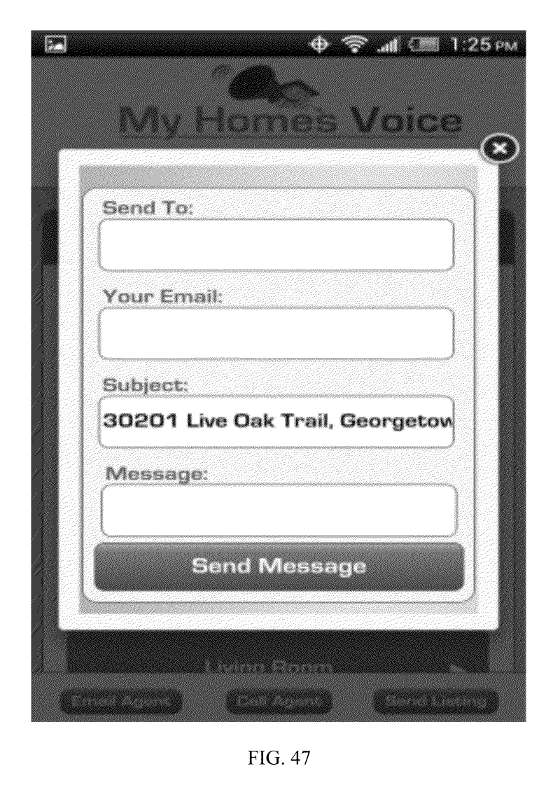

As illustrated in FIG. 45, the view GUI can also comprise selections for Emailing the Agent (alternatively texting the Agent), Calling the Agent, and/or Sending a Listing to a third party. Upon electing to email an agent the user can prepare and transmit an email/text to the listing agent for the current property, see FIG. 45 for an example of an Email the Agent screen. The email can be a question(s), a request for more details, and the like. Upon electing to call an agent the program can provide or dial the phone number of the listing agent, see FIG. 45 for an example of a Calling the Agent screen. In certain aspects the user can call to ask questions, to schedule a showing, etc. Upon electing to send a listing the device can display the user's email program and contacts for the purpose of forwarding an email or information related to a property to themselves or a third party (e.g., friends, agents, referrals, etc), see FIG. 47 for an example of a sending a listing screen.

Embodiments of system or methods described herein may be implemented or executed by one or more computer systems. In various embodiments, a system may be an authentication information transmitter, an monitoring device, a security gateway, or more generally a server, a mainframe computer system, a workstation, a network computer, a desktop computer, a laptop, a mobile device or the like. For example, in some cases, the system or methods described herein may be implemented as a computer system. Moreover, one or more systems or devices may include one or more computers or computing devices generally in the form of the system as described. In different embodiments various computer systems or components may be configured to communicate with each other in any suitable way, such as, for example, via a network.

A system includes one or more processors coupled to a system storage via an input/output (I/O) interface. A system further includes a network interface coupled to I/O interface, and one or more input/output devices, such as a monitoring device, a cursor control device, a keyboard, a display(s) and the like. In certain embodiments multiple devices make up the system and each device may be configured to host different portions or instances of embodiments or functions of the system. For example, some elements may be implemented via one or more devices of the system that are distinct from those devices implementing other elements.

In various embodiments, a system may be a multi-processor system including two or more processors (e.g., two, four, eight, or another suitable number). The processors may be any processor capable of executing program instructions. For example, in various embodiments, processors may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors may commonly, but not necessarily, implement the same ISA. Also, in some embodiments, at least one processor may be a graphics-processing unit (GPU) or other dedicated graphics-rendering device.

System storage may be configured to store program instructions and/or data accessible by one or more processors. In various embodiments, the system storage may be implemented using any suitable storage technology, such as static random access memory (SRAM), synchronous dynamic RAM (SDRAM), nonvolatile/Flash-type memory, or any other type of storage. Program instructions and data implementing certain operations, such as, for example, those described herein, may be stored within system memory as program instructions and data storage, respectively. In other embodiments, program instructions and/or data may be received, sent or stored upon different types of computer-accessible media or on similar media separate from system memory or computer system. Generally speaking, a computer-accessible medium may include any tangible storage media or memory media such as magnetic or optical media—e.g., disk or CD/DVD-ROM coupled to computer system via I/O interface. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via a network interface.

In certain embodiments, an I/O interface may be configured to coordinate I/O traffic between processor, system memory, and any peripheral devices, including network interface or other peripheral interfaces, such as input/output devices. In some embodiments, an I/O interface may perform any necessary protocol, timing or other data transformations to convert data signals from one component (e.g., system memory) into a format suitable for use by another component (e.g., processor). In some embodiments, an I/O interface may include support for devices attached through various types of peripheral buses, such as a variant of the Peripheral Component Interconnect (PCI) bus standard or the Universal Serial Bus (USB) standard, for example. In some embodiments, the function of the I/O interface may be split into two or more separate components, such as a north bridge and a south bridge, for example. In addition, in some embodiments some or all of the functionality of an I/O interface, such as an interface to system memory, may be incorporated directly into a processor.

A network interface may be configured to allow data to be exchanged between a system and other devices on a network, such as other computer systems, other devices, or between nodes of a computer system. In various embodiments, a network interface may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

The input/output devices may, in some embodiments, include one or more display terminals, keyboards, keypads, touch screens, scanning devices, voice or optical recognition devices, or any other devices suitable for entering or retrieving data by one or more systems. Multiple input/output devices may be present in a system or may be distributed on various nodes of the system. In some embodiments, similar input/output devices may be separate from the system and may interact with one or more nodes of the system through a wired or wireless connection, such as over a network interface.

Memory may include program instructions, configured to implement certain embodiments described herein, and data storage, comprising various data accessible by program instructions. In certain embodiments, program instructions may include software elements of embodiments described herein. For example, the program instructions may be implemented in various embodiments using any desired programming language, scripting language, or combination of programming languages and/or scripting languages (e.g., C, C++, C#, JAVA®, JAVASCRIPT®, PERL®, etc). Data storage may include data that may be used in these embodiments. Other or different software elements and data may be included.

A person of ordinary skill in the art will appreciate that the system and method described herein are merely illustrative and is not intended to limit the scope of the disclosure. In particular, the system and devices may include any combination of hardware or software that can perform the indicated operations. In addition, the operations performed by the components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other system configurations.

The examples provided herein, as well as the figures, are included to demonstrate certain embodiments of the invention. It should be appreciated by those of skill in the art that the systems, devices, methods, and techniques disclosed in the examples or figures represent those identified by the inventors to function well in the practice of the invention, and thus can be considered to constitute modes for its practice. However, those of skill in the art should, in light of the present disclosure, appreciate that many changes can be made in the specific embodiments which are disclosed and still obtain a like or similar result without departing from the spirit and scope of the invention.

1. A system for an enhanced presentation of a property comprising:
a server comprising a network interface, storage comprising information related to a plurality of properties, a server controller;
a communication network; and
a local device comprising a user interface, a global positioning function, a network interface, and a device controller, configured to provide location specific information to the local device based on the location of the device.

2. A mobile device configured to display customized location specific information based on location of the device.

3. A server configured to transmit customized location specific information in response to queries from a device present at a particular location.
